(19) United States
(12) Patent Application Publication
(10) Pub. No.: US 2026/0216630 A1
(43) Pub. Date: Jul. 30, 2026

(54) IMPROVED INDUSTRIAL DUST EXTRACTORS

(71) Applicant: HUSQVARNA AB, Huskvarna (SE)

(72) Inventors: Axel SJOBERG, Huskvarna (SE); Robert KUSEL, Huskvarna (SE); Elon WENNBERG, Huskvarna (SE)

(21) Appl. No.: 19/148,534

(22) PCT Filed: Jan. 4, 2024
(86) PCT No.: PCT/EP2024/050165

§ 371 Date: Jul. 16, 2025

(30) Foreign Application Priority Data
Jan. 16, 2023 (SE) 2350029-1
Jan. 16, 2023 (SE) 2350030-9
Jun. 19, 2023 (SE) 2350747-8
Jun. 19, 2023 (SE) 2350748-6
Jun. 19, 2023 (WO) PCT/SE2023/050629
Oct. 20, 2023 (WO) PCT/EP2023/079221

(51) Int. Cl. B01D 46/71; B01D 45/12; B01D 50/00

(52) U.S. Cl. CPC B01D 46/71; B01D 45/12; B01D 50/00

(57) ABSTRACT

A control unit (170) for a heavy duty dust extractor (100), where the control unit (170) is arranged to trigger generation of reverse pulses of air (310, 410, 510) for cleaning a filter (125) of the dust extractor (100) according to a pulse repetition frequency (320), where the control unit (170) is arranged to determine a particle load level associated with the filter (125), and where the control unit (170) is arranged to configure the pulse repetition frequency as an increasing function of the particle load level.

### TECHNICAL FIELD

The present disclosure relates to heavy duty dust extraction devices for use with construction equipment such as concrete grinders and saws. There are disclosed dust extractors, methods, and control units for verifying and controlling a filter function in a dust extractor. Techniques for efficient cleaning of filters in dust extractors are described, as well as improved methods for evacuating dust from a cyclone into a dust container arranged underneath the cyclone. There are also disclosed fleet management systems for monitoring and servicing a plurality of dust extractors.

### BACKGROUND

Dust is created by cutting, drilling, grinding and/or demolishing concrete, brick, and other hard construction materials. The dust may be collected by a dust extractor and removed from the construction site in a controlled manner. Dust extractors are vacuum devices which collect the dust by generating a vacuum or an under-pressure by means of at least one fan or impeller and motor arrangement, i.e., similar to a vacuum cleaner. Many industrial grade dust extractors comprise a cyclone or separator with a pre-filter followed by an essential filter such as a high-efficiency particulate air (HEPA) filter.

The dust created by cutting, drilling, grinding and/or demolishing concrete, brick, and other hard construction materials may be harmful to a person located at the work site. The filter function, and the function of the essential filter in particular, is important in order not to negatively affect operator health and pollute the environment. A dust extractor without a correctly installed essential filter represents a safety hazard which is to be avoided.

The filters in a dust extractor gradually become particle-laden by particulate matter during operation. A clogged filter has an adverse effect on the performance of the dust extractor and needs to be cleaned or replaced with a new filter. However, cleaning or replacing filters too often adds an unnecessary overhead to the dust extraction operation which is to be avoided.

There is a need for improved filter management functions for industrial dust extractors which allow both efficient, clean as well as safe dust extraction.

### SUMMARY

It is an objective of the present disclosure to provide improved monitoring and filter control functions for industrial dust extractors. This objective is at least in part obtained by a control unit for a heavy duty dust extractor, where the control unit is arranged to trigger generation of reverse pulses of air for cleaning a filter of the dust extractor according to a pulse repetition frequency. The control unit is arranged to determine a particle load level associated with the filter and to configure the pulse repetition frequency as an increasing function of the particle load level. The reverse pulses of air are generated by the control unit by operating a valve arrangement which abruptly opens and closes a passage between a clean side of the filter of the dust extractor and atmospheric pressure, which generates pulses of air. This is an advantage since an on-board compressed air source for generating the reverse pulses of air is not necessary.

This way the filter cleaning operation is not performed too often when the filter is not particle-laden and not in need of cleaning, and more often when more particles have adhered to the filter outside wall. The reduction in dust extraction performance during filter cleaning is therefore reduced at low particle loads, which is an advantage. The filter cleaning method and the control unit performing the method are particularly suitable for use in cleaning pre-filters of a dust extractor, such as the filters normally found inside a dust accumulation tank or cyclone, but they can also be used together with other types of dust extraction filters.

According to some aspects, the dust extractor comprises two or more essential filters and/or two or more pre-filters, either implemented as separate filter units or as a single filter unit that is split into two or more filter compartments. These filters can be cleaned separately in an interleaved manner, such that dust extraction can continue using one filter while another filter is being cleaned by a reverse pulse of air. To achieve this improvement, each filter, or each filter compartment is associated with a respective valve arrangement for cleaning the filter or the filter compartment. The control unit is then arranged to control these valve arrangements in a time synchronized manner.

The control unit is optionally arranged to obtain a differential pressure measurement over the filter, and to determine the particle load level based on the differential pressure measurement. This is a robust filter load measurement technique which can be implemented at limited cost, which is an advantage. The control unit may also be arranged to obtain a downstream pressure measurement associated with an air pressure downstream from the filter, and to determine the particle load level based on the downstream pressure measurement. This may in some cases be an even more cost efficient implementation. The downstream pressure measurement may be related to atmospheric pressure or to some other reference pressure. The downstream pressure measurement may be used in combination with the differential pressure measurement over the filter. An average pressure measurement associated with the filter (differential over the filter and/or downstream from the filter) is preferably used, where the pressure sensor data has been averaged over an averaging time period, to reduce variation in the measurement due to variation in system pressure, and to suppress measurement noise.

According to some aspects, the control unit is arranged to configure a zero pulse repetition frequency in case the particle load level is below a pre-determined filter cleaning activation threshold. Thus, there is no unnecessary filter cleaning triggered if the filter is, e.g., brand new and not in need of cleaning.

According to some aspects, the control unit is arranged to limit the pulse repetition frequency to be below a pre-determined maximum pulse repetition frequency. This feature may be advantageous in some dust extractors, where a too high pulse repetition frequency may lead to a reduced cleaning performance. A maximum pulse repetition frequency can be configured in such cases based, e.g., on practical experimentation, beyond which no further cleaning improvement is seen regardless of filter particle load.

According to some aspects, the control unit is arranged to configure the pulse repetition frequency as an increasing polynomial function over a pre-determined range of particle load levels. The polynomial function allows large freedom in the design of the function. The function can therefore be tailored to a specific use case and dust extractor, which is an advantage.

The control unit may also be arranged to control a time duration of each reverse pulse of air as a pre-determined function of the particle load level. The time duration also plays a role in determining the cleaning performance of a pulse of air, and it is an advantage that this duration can be adapted to the current particle load situation. It is appreciated that the time duration can be controlled regardless of whether the repetition frequency is controlled or not. I.e., there is also disclosed herein A control unit for a heavy duty dust extractor, where the control unit is arranged to trigger generation of reverse pulses of air for cleaning a filter of the dust extractor according to a pulse repetition frequency. The control unit is arranged to determine a particle load level associated with the filter and to control a time duration of each reverse pulse of air as a pre-determined function of the particle load level, independently of whether the pulse repetition frequency is fixed or variable.

According to some aspects, the control unit is arranged to determine a first particle load level within a pre-determined time period before a generated reverse pulse of air and a second particle load level within a pre-determined time period after a generated reverse pulse of air. The control unit then determines a cleaning efficiency metric based on the difference between the first particle load level and the second particle load level. This cleaning efficiency metric can, e.g., be reported to a user of the dust extractor such as on a display device, or presented in a fleet management system, where it can be used for monitoring and diagnostics purposes. The control unit may also be arranged to configure the pulse repetition frequency and/or the pulse time duration as an increasing function of the cleaning efficiency metric.

The control unit is optionally also arranged to trigger a super-clean procedure in response to the cleaning efficiency metric and/or the particle load level breaching a super-clean trigger threshold, where the super-clean procedure comprises blocking an inlet of the dust extractor and triggering generation of a series of reverse pulses of air for cleaning the filter. This super-clean procedure may dislodge dust particles which have become stuck to the filter wall, and thus improve the particle load level in cases where the normal air pulsing is not effective. The blocking of the inlet of the dust extractor optionally comprises issuing an instruction to a user to manually block the inlet or controlling an automatic inlet blocking device of the dust extractor to block the inlet.

According to some aspects, the control unit is arranged to update a filter cleaning counter each time a reverse pulse of air for cleaning the filter is triggered, and to determine a filter state based on the value of the filter cleaning counter. This filter cleaning counter is a good statistic which indicates filter wear. It can be used to indicate when a filter is in need of replacement or servicing. It can also be used in a fleet management system to get an overview of current filter wear states in a fleet of dust extractors. Thus, the control unit can be arranged to display the filter state on a display device and also to trigger generation of a notification message in case the value of the filter cleaning counter exceeds a pulse counter threshold.

There is also disclosed a fleet management system comprising a server operatively connected to a database for managing a plurality of dust extractors such as those discussed herein. The server is arranged to obtain data related to one or more filter arrangements comprised in the dust extractors and to maintain an information record in the database for each of the one or more filter arrangements, and also to schedule a filter maintenance operation or a filter replacement operation based on the maintained information records.

The above-mentioned objective is also at least in part obtained by a control unit for a heavy duty dust extractor, where the dust extractor comprises a blower system arranged to generate a variable air flow through one or more filters of the dust extractor. The control unit is arranged to configure at least a first air flow and a second air flow by the blower system, and to obtain an air pressure measurement for each configured air flow, where the air pressure measurement is indicative of an air pressure drop across at least one of the filters of the dust extractor. The control unit is also arranged to determine a nominal relationship between air pressure and air flow based on the obtained air pressure measurements, and to configure at least one operating parameter of the dust extractor based on the nominal relationship between air pressure and air flow. Various operating parameters can be configured in this manner, such as a missing filter detection threshold or other criterion, a damaged filter detection criterion, a particle-laden filter detection criterion, and also the pulse repetition frequency and/or pulse time duration of a filter cleaning function as discussed above. This configuration of operating parameters will then be tailored to the specifics of the given system, which is an advantage. For instance, the dust extractor will be able to adjust its operating parameters automatically in case a new type of filter of unknown filter specification and/or unknown filter characteristics is inserted, or if some other aspect of its geometry or specification changes, which is an advantage.

According to some aspects, the control unit is arranged to configure air flow by the blower system based on a configured fan speed or drawn motor power of the blower system and on a predetermined relationship between fan speed or motor power and air flow through the one or more filters of the dust extractor. The control unit may also be arranged to configure air flow by the blower system based on a measured air flow through the one or more of the dust extractor, where the measured air flow is obtained from any of an anemometer flow meter arrangement, a pitot pipe flow meter arrangement, and/or a venturi flow meter arrangement.

The control unit may be arranged to configure the first and second air flows in response to a filter characterization trigger signal, e.g., triggered by a user having inserted a new filter into the dust extractor, or wanting to tailor operating parameters of the dust extractor to better fit the current characteristics of the dust extractor. The filter characterization trigger signal is, for instance, preferably triggered in connection to a filter replacement operation.

According to some aspects, the control unit is arranged to determine the nominal relationship between air pressure and air flow as a polynomial function fit to the configured air flows and corresponding air pressure measurements. This is a relatively low complexity implementation of the dust extractor characterization, which can be performed without significant computational burden. This is an advantage in case the dust extractor lacks powerful processing circuitry, which it normally the case.

The control unit may be arranged to sweep the variable air flow from a low airflow level to a high air flow level and monitor the air pressure measurement value during the variable air flow sweep. Thus, the pressure vs air flow characteristics of the dust extractor are obtained over the entire range, which is an advantage.

The control unit is preferably arranged to obtain each air pressure measurement after a pre-determined settling time duration while holding the configured air flow at a constant value. This allows for transient effects to settle before data is captured, which is an advantage since more accurate data is then obtained.

The control unit is optionally arranged to obtain each air pressure measurement as a differential pressure measurement over a pre-filter and/or over an essential filter of the dust extractor. This type of differential pressure measurement captures the characteristics of an individual filter or local part of the dust extraction system, allowing individual evaluation of separate dust extractor components, which is advantage.

According to some aspects, the control unit is arranged to obtain each air pressure measurement as a downstream pressure measurement associated with an air pressure downstream from the pre-filter or downstream from the essential filter of the dust extractor. These downstream pressure measurements capture effects of all the components upstream from the measurement point, but still provide valuable input data. Some dust extractors only comprise these pressure sensors, and it is an advantage that the techniques discussed herein can be used also with such pressure sensor systems.

According to some aspects, the control unit is arranged to determine a current relationship between air pressure and air flow based on a repeated set of obtained air pressure measurements versus air flow, where the control unit is arranged to compare the current relationship to the nominal relationship and to determine a current filter state based on a difference between the current and nominal relationships between air pressure and air flow. This input data has been shown to accurately indicate filter state. It can, e.g., be used to determine when it is time to replace or service a filter. The data can also be used to monitor filter state in a fleet of dust extractors, e.g., by storing a histogram of the data.

There is also disclosed herein a fleet management system comprising a server operatively connected to a database for managing a plurality of dust extractors. The server is arranged to obtain data related to one or more filter arrangements comprised in the dust extractors and to maintain an information record in the database for each of the one or more filter arrangements, and to schedule a filter maintenance operation or a filter replacement operation based on the maintained information records.

Aspects of the present disclosure also relate to a control unit for a heavy duty dust extractor. The control unit is arranged to trigger generation of reverse pulses of air for cleaning a filter of the dust extractor by opening and closing a valve arrangement. As discussed above, the valve arrangement can be associated with a source of compressed air, or with a passage to an external ambient environment of the dust extractor, although passage to an external ambient environment of the dust extractor is the preferred option. The control unit is arranged to execute a dumping operation comprising generation of a compact sequence of short reverse pulses of air followed by a longer reverse pulse of air. The compact sequence of short reverse pulses of air generates a type of vibration in the cyclone which unsettles accumulated dust, making it easier to evacuate the dust from the cyclone, which is an advantage. The evacuation is triggered by the longer reverse pulse of air. In other words, the dust extractor first pulses rapidly using the valve arrangement or arrangements to unsettle the dust in preparation for dumping, and then dumps the dust into a dust container arranged below the cyclone. The operation is akin to first shaking the dust extractor and then forcefully opening the bottom of the cyclone to allow the unsettled dust to fall down into the dust container arranged underneath the cyclone.

The control unit can for instance be arranged to control a first valve arrangement and a second valve arrangement, where each valve arrangement opens and closes a passage between a clean side of a respective filter of the dust extractor and atmospheric pressure. The dumping operation then comprises generation of compact sequences of short reverse pulses of air by the first valve arrangement and by the second valve arrangement, followed by a longer at least approximately time-aligned reverse pulse of air by the first valve arrangement and by the second valve arrangement. This way of dumping dust from the cyclone into a dust container arranged underneath the cyclone has been found to be very effective for many types of dust, in particular dust that has a tendency to settle into a cake-like mass at the bottom of the cyclone.

The compact sequences of short reverse pulses of air by the first valve arrangement and by the second valve arrangement can be aligned in time or interleaved in time, as will be discussed in more detail in the following.

Aspects of the present disclosure furthermore relate to a vibration function suitable for heavy-duty dust extractors. There is disclosed a dust extractor comprising a cyclone, a filter, a valve arrangement, and a control unit. The valve arrangement is arranged to abruptly open and close a passage between a clean side of the filter of the dust extractor and atmospheric pressure and the control unit is arranged to control the valve arrangement to generate a vibration of the cyclone, by repeatedly opening and closing the valve arrangement according to a compact sequence of short reverse pulses of air, where the compact sequence of short reverse pulses of air comprises at least two short pulses in a time period of 200 ms. For example, a short pulse can be of duration about 75 ms, and the time inbetween short pulses can be in the same order, i.e., also about 75 ms. Two or three short pulses can be triggered in sequence followed by a longer pulse of a time duration on the order of 400-600 ms or so. This dumping operation will first prepare the dust for dumping by unsettling it using a vibration, and then release the pressure in the cyclone by the longer pulse so that the dust in the cyclone is evacuated into the dust container arranged underneath the cyclone.

This way the dust that has accumulated inside the cyclone can be treated so as to become less settled, i.e., less compact, which facilitates evacuation of the dust from the cyclone, e.g., into a dust container arranged underneath the cyclone.

There are also disclosed herein dust extractors, fleet management systems, display devices, methods and computer program products associated with the above-mentioned advantages.

Generally, all terms used in the claims are to be interpreted according to their ordinary meaning in the technical field, unless explicitly defined otherwise herein. All references to “a/an/the element, apparatus, component, means, step, etc.” are to be interpreted openly as referring to at least one instance of the element, apparatus, component, means, step, etc., unless explicitly stated otherwise. The steps of any method disclosed herein do not have to be performed in the exact order disclosed, unless explicitly stated. Further features of, and advantages with, the present invention will become apparent when studying the appended claims and the following description. The skilled person realizes that different features of the present invention may be combined to create embodiments other than those described in the following, without departing from the scope of the present invention.

### BRIEF DESCRIPTION OF THE DRAWINGS

The present disclosure will now be described in more detail with reference to the appended drawings, where

FIGS. 1A-B illustrates an example dust extractor with filters;

FIGS. 2-3 schematically illustrate example filter operations;

FIGS. 4, 5A-B are graphs illustrating example filter cleaning operations;

FIG. 6 is a graph showing example relationships between air flow and pressure drop over one or more filters;

FIGS. 7A-C illustrate configuration of dust extractor operating parameters.

FIGS. 8, 9A-B illustrate example display units;

FIGS. 10A-C are flow charts illustrating methods;

FIG. 11 shows general hardware of an example control unit or server;

FIG. 12 schematically illustrates a computer program product;

FIGS. 13-14 illustrate detection criteria as function of air flow;

FIG. 15 illustrates a dumping operation for evacuating dust from a cyclone;

FIG. 16 shows a heavy-duty dust extractor with a split filter arrangement;

FIG. 17 illustrates a split pre-filter with two separate filter compartments;

FIGS. 18A-B are graphs illustrating dumping operations with dual filters;

FIGS. 19A-B illustrate an example of air pulse timing;

FIGS. 20, 21A-B illustrate an example valve arrangement;

### DETAILED DESCRIPTION

The invention will now be described more fully hereinafter with reference to the accompanying drawings, in which certain aspects of the invention are shown. This invention may, however, be embodied in many different forms and should not be construed as limited to the embodiments and aspects set forth herein; rather, these embodiments are provided by way of example so that this disclosure will be thorough and complete, and will fully convey the scope of the invention to those skilled in the art. Like numbers refer to like elements throughout the description.

It is to be understood that the present invention is not limited to the embodiments described herein and illustrated in the drawings; rather, the skilled person will recognize that many changes and modifications may be made within the scope of the appended claims. In particular, the technical features associated with the configuration of pulse repetition frequency, pulse time duration, and general filter maintenance can be advantageously combined with the technical features relating to the characterization of system pressure behavior in dependence of air flow through the system, such as the configuration of operating parameters of the dust extractor based on the nominal relationship between air pressure and air flow discussed below.

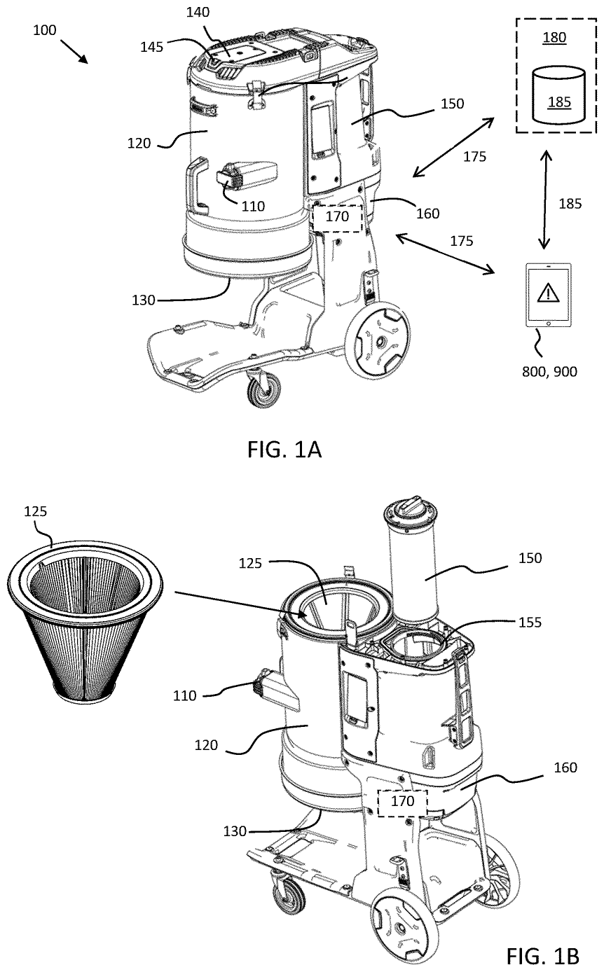

FIGS. 1A and 1B illustrate an example dust extractor 100 which can be connected via a hose to a dust generator (not shown in FIGS. 1A-B), such as a core drill, a floor grinder, a concrete saw, or the like. The dust from the dust generator enters the dust extractor via an inlet 110. A cyclone or tank 120 is arranged after the inlet, i.e., downstream with respect to the airflow direction into the inlet 110. The cyclone 120 may, e.g., comprise a pre-filter for separating out larger debris particles from the particle-laden airflow entering the inlet 110. An example pre-filter 125 is shown in FIG. 1B. The larger debris particles trapped by the cyclone 120 may be collected via an outlet 130 of the cyclone 120, e.g., in a disposable plastic bag, such as a Longopac dust container system, or other dust container.

The teachings herein are applicable for cleaning a pre-filter as illustrated in FIG. 1B, but also for cleaning a more general filter, such as a filter in a single filter dust extraction system.

The term cyclone is to be construed broadly herein to comprise any form of pre-separator system, i.e., a tank structure with or without filter arranged to capture more coarse dust particles in a particle laden air stream.

The air flow continues from the cyclone 120 via one or more conduits 140 into one or more essential filters 150. An essential filter is an air filter designed to meet strict requirements on filtering function. The conduit arrangement transporting air between the cyclone 120 and the essential filter 150 is preferably integrally formed with a body of the dust extractor 100 as shown in FIGS. 1A-B.

The essential filter 150 may, e.g., be a High-Efficiency Particulate Air (HEPA) filter, but other air filters may also be used. HEPA, also known as high-efficiency particulate absorbing and high-efficiency particulate arrestance, is an efficiency standard of air filters. Filters meeting the HEPA standard must satisfy certain levels of efficiency. HEPA was commercialized in the 1950s, and the original term became a registered trademark and later a generic term for highly efficient filters. It is noted that the techniques disclosed herein can be applied to dust extraction devices with any number of air filters 150, including dust extraction devices comprising combinations of different air filters. The essential filter is normally arranged in a filter holder 155, as exemplified in FIG. 1B. Cylindrically shaped essential filters are common, but rectangular and other shapes of essential filters are also known. Essential filters are known in general and will therefore not be discussed in more detail herein.

A blower arrangement 160 is arranged downstream from the one or more essential filters 150. Depending on performance characteristics, and without loss of generality, the blower arrangement 160 may also be referred to as a fan arrangement or a compressor arrangement. Pressure ratio or pressure rise is defined herein as the ratio of the impeller discharge pressure to the impeller inlet pressure, which is sometimes also referred to as suction pressure. In general, a blower has a slightly higher pressure rise than a fan: from 1.11 to 1.2. For applications where the required pressure rise is greater than 1.2, the device is usually referred to as a compressor, because more ‘compression’ is done. The term ‘blower’ will be used throughout this disclosure, although it is appreciated that the techniques disclosed herein are suitable for use with both fans, blowers, and compressors.

The blower arrangement generates a suction force, i.e., a vacuum or an under-pressure relative to atmospheric pressure which draws the particle-laden airflow in through the inlet 110, past the cyclone 120, and through the one or more essential filters 150. Herein, an under-pressure value indicates how far below a reference pressure level, such as atmospheric pressure, the pressure in the airflow is. Under-pressure is as mentioned above also sometimes referred to as vacuum level.

The dust extractors 100 shown in FIGS. 1A-B also comprise a control unit 170, only schematically indicated in FIGS. 1A-B. The control unit 170 is configured to control various operations by the dust extractor such as activating the motor to drive the impeller in the blower arrangement 160 in order to generate the suction force, controlling the fan speed, and measuring various operating parameters of the dust extractor. This control unit will be discussed in more detail below in connection to FIG. 11.

The heavy-duty dust extractor 100 is arranged to perform a dumping operation, where dust and debris accumulated in the cyclone or tank 120 is evacuated into a dust container (not shown in FIG. 1) that is arranged underneath the cyclone 120. During dumping, a hatch or other closure mechanism at the bottom of the cyclone 120 opens up to allow the accumulated dust to fall down into the dust container arranged underneath.

This type of dumping operation can be triggered automatically by the weight of the accumulated dust, manually by triggering a long reverse pulse of air that increases the pressure inside the cyclone, or automatically triggered by the control unit 170, as will be discussed in more detail below.

At least some of the dust extractors discussed herein comprise variable air flow blower arrangements 160 which the control unit 170 can control in order to configure a desired air flow. The control unit 170 may, e.g., be configured to control a fan motor speed in order to set a first air flow and a second air flow different from the first airflow by the blower system 160. The control unit 170 may comprise a data storage where a pre-determined mapping between fan speed and air flow is tabulated. The control unit 170 can also use the current drawn by the blower motor to estimate current air flow. The control unit 170 may also be connected to one or more air flow sensors arranged along the air flow path from the inlet 110 to the essential filter holder 155, and thus receive data regarding a current air flow in the system. The control unit 170 may then adjust a fan speed or fan motor power in order to obtain a target air flow through the dust extractor 100. Hence, the control unit 170 is in a position to control a level of a variable air flow of the dust extractor from a low air flow level to a high airflow level over a range of air flows, in discrete steps or continuous over some range of air flows.

The inlet 110 of the dust extractor 100 may comprise an automatic inlet blocking device which is controllable from the control unit 170. The control unit can use this device to close the inlet, e.g., in order to generate a vacuum inside the cyclone. A filter cleaning operation involving a reverse thrust of air pushed through the pre-filter 125 will be more efficient in case the cyclone interior has low air pressure, which will be the case if the inlet 110 is blocked by the automatic blocking device. Filter cleaning using reverse thrusts of air, or air pulses, will be discussed in more detail below in connection to FIGS. 3-5.

A server 180 may be arranged in combination with one or more dust extractors and/or display units 800, 900. This server 180 may form part of a fleet management system for monitoring and controlling a plurality of construction equipment comprising several dust extractors and also other equipment such as core drills, floor grinders, concrete saws, and the like. A function of this fleet management system may be to monitor a filter function of one or more dust extractors, and to facilitate maintenance of the dust extractors such that the dust extraction performance is maintained at a high level in an efficient manner.

The control unit 170 integrated with the dust extractor 100 may be arranged to communicate over wireless or wired communication link 175 to the display unit 800, 900 and/or to the server 180. The server 180 may also be arranged to communicate directly with the display unit 800, 900 over wired or wireless link 185. These communication links 175, 185 may be based on any known communication system, such as a Bluetooth wireless link, Wi-Fi, cellular communications, Ethernet, or the like. Such data communication links are generally known and will therefore not be discussed in more detail herein.

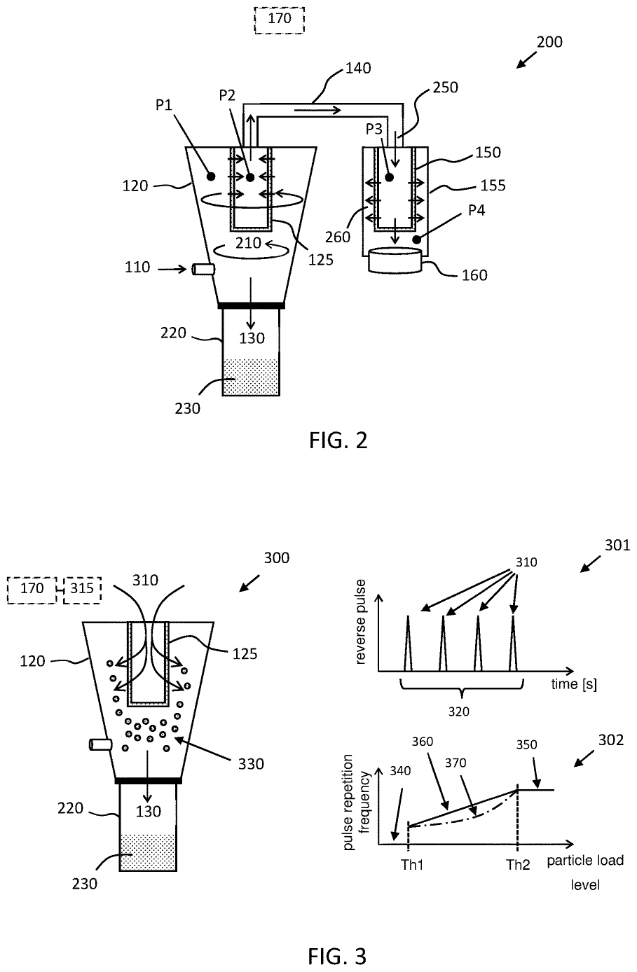

FIG. 2 schematically illustrates a filter arrangement 200 for a heavy duty dust extractor 100 such as those shown in FIGS. 1A-B. This filter arrangement comprises a cyclone 120 connected upstream from an essential filter 150, i.e., between the inlet 110 and the essential filter 150.

Particle laden air enters the filter arrangement via the inlet 110 into the cyclone 120 where a rotation 210 of the air flow is induced. A dust container 220 collects the heavier particles and debris 230 that are trapped by the cyclone 120. This dust container 220 may, e.g., be a disposable plastic bag or a removable container. A pre-filter 125 filters the air flow before it enters the conduit 140 between the cyclone 120 and the essential filter arrangement.

The pre-filter 120 may be cleaned by generating a reverse thrust of air 310 through the filter wall as illustrated in FIG. 3. This reverse thrust of air 310 loosens particulate matter 330 which has become adhered to the pre-filter wall, such that it falls down into the dust container 220. The dust extraction performance of the dust extractor 100 of course reduces during the generation of the air pulse 310. Hence, filter cleaning should not be performed more often than necessary. Closing the inlet 110 in connection to generating the reverse thrust of air normally improves the filter cleaning effect of the pulse. The inlet 110 may be manually closed or automatically by an inlet blocking device which is controllable from the control unit 170.

The reverse thrust of air 310 may according to some aspects be triggered by actuation of a source of compressed air, as described in, e.g., US 2013/0239802 A1. The compressed air from the compressed air source flows into the clean side of the filter being cleaned and pushes particulate matter 330 away from the outside filter walls, as illustrated in FIG. 3. The control unit 170 can control the source of compressed air to generate short impulse-like pulses of air and also longer pulses of air.

It is noted that the filter cleaning arrangement from US 2013/0239802 A1 cannot be applied in a heavy-duty dust extractor for industrial use, since the dust is evacuated via a spring loaded pulse pressure vent that releases dust into the ambient environment. According to standard IEC 60335-2-69:2016 par. 22.AA.212, machines of dust classes M or H shall not be equipped with an inflating function, i.e., a dust extractor must not be pressurized so that it releases dust into the environment, which the design in US 2013/0239802 A1 does via the spring loaded pulse pressure vent.

According to some aspects, the dust extractors discussed herein are of dust classes M or H, discussed in standard IEC 60335-2-69:2016.

Having an on-board source of compressed air is not ideal for many types of heavy-duty dust extractors, in particular for portable heavy-duty dust extractors of the kind illustrated in FIG. 1. This is because the compressed air source adds weight and cost to the machine, and it also needs to be refilled regularly.

It has been realized that efficient filter cleaning can also be accomplished by a valve arrangement that opens up a passage between the clean side of the filter to be cleaned and atmospheric pressure, i.e., a conduit leading between the external ambient environment of the dust extractor and the clean side of the filter. When this type of passage is abruptly opened up, a gush of air flows rapidly into the filter and causes a similar effect to that of a compressed air source system. Aspects of the techniques disclosed herein relate to filter cleaning systems based on valve arrangements that open up passages between the clean side of the filter to be cleaned and the ambient environment of the dust extractor.

The valve arrangement that opens up a passage between the clean side of the filter and the ambient environment is preferably arranged in the lid 145 of the dust extractor. The valve arrangement can be possible to actuate manually by a button or the like, or automatically by the control unit 170, as will be discussed in more detail below.

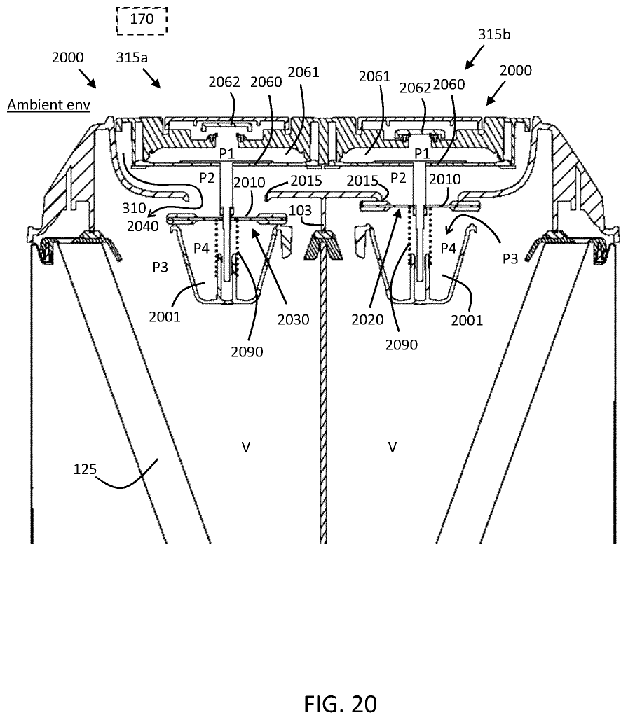

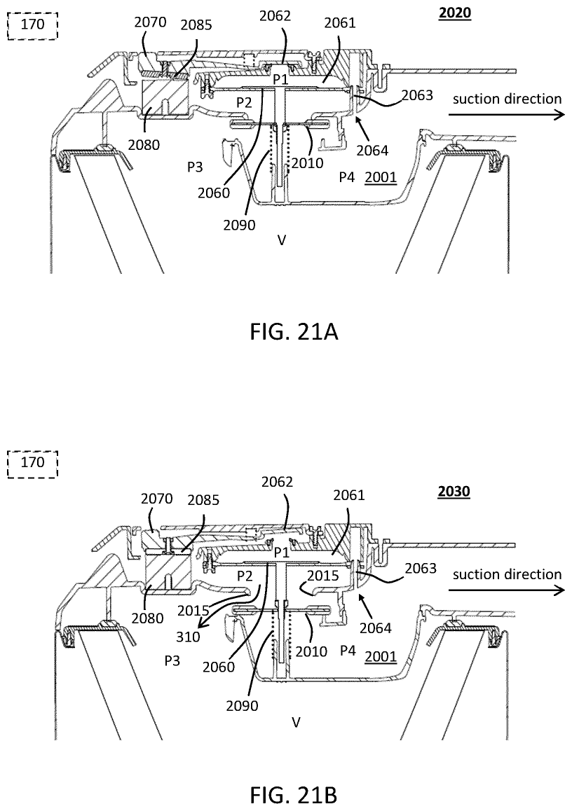

FIG. 3 schematically illustrates a valve arrangement 315 which opens and closes a passage between a clean side of a filter 125 of the dust extractor 100 and atmospheric pressure. This valve arrangement 315 can be controlled by the control unit to generate reverse pulses of air 315 to perform a filter cleaning operation. An example valve arrangement capable of generating abrupt pulses of air of limited time duration will be described below in connection to FIG. 20 and FIGS. 21A-B.

The valve arrangement 315 can be arranged in the lid 145 of the dust extractor, above the pre-filter 125. The valve arrangement 315 may comprise an actuator such as a solenoid, servo motor, spring-loaded trigger device, or other electrically actuated device which opens and closes a valve to temporarily connect the clean side of the filter to the outside environment, such that air rushes into the clean side of the filter and pushes dust away from the outer dirty filter wall.

According to some aspects, the control unit is arranged to detect when a user manually or by some actuator blocks the inlet 110 and perform a filter cleaning operation in response to detecting the blockage. The detection may be performed based on pressure sensor data, e.g., any of the pressures P1−P4 in FIG. 2. The pressure P1 may for instance be used in combination with the pressure difference P1−P2. Upon blockage of the inlet 110, the pressure P1 will fall and the pressure difference between P1 and P2 will even out.

The control unit 170 may, e.g., trigger a rapid sequence of reverse air pulses to clean the pre-filter 125 in response to detecting that the inlet 110 is blocked.

The air pulses, i.e., the reverse thrusts of air 310, are normally generated at a pulse repetition frequency 320, as illustrated in the insert graph 301 in FIG. 3. A pulse repetition frequency is a metric that is indicative of how often an air pulse is generated. The air pulses may be generated periodically with an even time period inbetween or more randomly. A pulse repetition frequency can be determined as the average number of pulses in a given time period, such as the average number of pulses generated over a time period of 5 minutes or so. The pulse repetition frequency is advantageously configured by the control unit 170 as a function of the pre-filter particle load level, as will be explained in more detail below. The pulse repetition frequency may, e.g., be configured as a polynomial function 360, 370 of pre-filter particle load level, as illustrated in the insert graph 302 in FIG. 3.

Referring again to FIG. 2, the air pressure in the cyclone, exterior to the pre-filter 125, is denoted P1, while the air pressure immediately downstream from the pre-filter, or internal to the pre-filter 125, is denoted P2. Normally there is a pressure drop over the pre-filter, i.e., during normal operation P1>P2.

A filter holder 155 fixes the essential filter 150 in position. The essential filter 150 comprises a filter inlet 250 and a filter outlet 260. An inlet air pressure P3 is associated with the filter inlet 250 (often the same pressure as or at least similar to pressure P2). An outlet air pressure P4 is associated with the filter outlet 260. During normal dust extraction operation, there is a pressure drop also over the essential filter 150, i.e., P3>P4 during normal dust extraction operation. Normally, the interior pre-filter pressure P2 is similar in magnitude to the essential filter inlet air pressure P3, but some pressure drop may occur along the conduit 140.

The magnitude of the pressure drop |P1−P2| and |P3−P4| is a function of the particle load of the respective filter. When the pre-filter 125 or the essential filter 150 is fully particle laden, i.e., clogged, the blower arrangement 160 will build a vacuum downstream from the filter. This means that there will be a relatively large pressure drop over the filter. During normal operation, i.e., when the filter is not fully particle laden, the pressure drop will be smaller. For filters arranged in series, such as schematically shown in FIG. 2, air pressure P1 is greater than the air pressure P2, which is similar to or slightly larger than the air pressure P3, that in turn is greater than the air pressure P4, i.e., P1>P2≥P3>P4.

If an essential filter 150 is not present in the filter holder 155, then the essential filter inlet air pressure P3 will be equal to or at least very similar to the essential filter outlet air pressure P4. It has been realized that this condition, i.e., P3≈P4, can be used to verify that an essential air filter is correctly installed in the dust extractor 100. The expected pressure drop over a filter in absolute terms is a function of the flow of air through the system. Hence, as will be explained in more detail in the following, air flow through the system is preferably accounted for when evaluating if a filter is present and functional, damaged, or missing.

A leakage in the essential filter 150 can be detected by monitoring the pressure difference P3−P4 (or P2−P4). A small pressure difference P3−P4 or P2−P4 can be used to detect leakage in the essential filter 150.

A fully laden or clogged essential filter 150 in need of cleaning (e.g., by a reverse thrust of air 310) or replacement can also be detected by monitoring the pressure difference P3−P4. A too large pressure difference P3−P4 is indicative of a fully particle laden essential filter 150.

However, the different pressure drop values in the system (either differential system pressure values or pressure relative to atmospheric pressure) seen when a filter is missing, damaged, clogged or otherwise malfunctioning depends on the specifics of the filter system, i.e., the geometry of the filters, the material used in the filters, the dimensions and general shape of the different air conduits and volumes in the system, and so on. Hence, the different detection criteria used in applications such as the above-mentioned often needs to be configured specifically for each type of dust extractor, and for each filter configuration. Thus, if a new type of filter is used in a dust extractor, the software of the control unit 170 used to, e.g., detect a missing filter condition and/or a damaged filter condition needs to be updated. This may be an inconvenience at best, and a serious health hazard at worst since the various detection mechanisms of the dust extractor may malfunction as a result of a filter replacement.

Pre-filter cleaning operations using reverse thrusts of air, as discussed above in connection to FIG. 3, may be triggered based on a measured pressure drop over the pre-filter, i.e., by comparing the pressure difference |P1−P2| to some form of detection criterion, such as a threshold. However, as will be discussed in the following, this pressure drop is often highly dependent on the air flow through the system. Thus, if the air flow through the system changes, the pre-filter cleaning operation trigger criteria may need to be updated in order to avoid too frequent cleaning, or too infrequent pre-filter cleaning. Suitable thresholds for use in controlling pre-filter cleaning operations are of course also dependent on the specifics of the filter system, i.e., the geometry of the filters, the material used in the filters, the dimensions and general shape of the different air conduits and volumes in the system, and so on.

If information related to the pressure at P1 is not available at the control unit 170, then an absolute pressure measurement (relative to atmospheric pressure or relative to some other reference pressure) at P2, P3 or P4 can be used for the same function, albeit with reduced performance since this measurement will be dependent on equipment connected upstream from the pre-filter, such as the length of hose used or the characteristics of the dust generator.

It has been realized that a suitable pre-filter cleaning pulse repetition frequency can be configured by the control unit 170 as an increasing function of pre-filter particle load level. This way the pre-filter will not be unnecessarily “pulsed” by a reverse thrust of air if it is not particle laden. Also, a particle laden pre-filter where particle load rises quickly during use will be pulsed more frequently compared to a pre-filter where particle load rises more slowly. The control unit 170 can be arranged to measure an increase in particle load, e.g., indicated by differential pressure P1−P2 or by an absolute pressure (relative to atmospheric pressure or relative to some other reference pressure) P2, P3 or P4, over a time period, and control pulsing based on this determined particle load time derivative. A frequency analysis of the particle load over time can also be used to find a filter clogging frequency and control the pre-filter cleaning operations based on this determined filter clogging frequency. It is noted that some type of low-pass filtering or averaging of the measured pressures in the system is preferred, since this measured pressure often varies significantly over the shorter time period due to variation in dust amount and other operating conditions.

To summarize, there is disclosed herein a control unit 170 for a heavy duty dust extractor 100, where the control unit 170 is arranged to trigger generation of reverse pulses of air 310, 410, 510 for cleaning the pre-filter 125 according to a pulse repetition frequency 320. The pulse repetition frequency may, as mentioned above, be a measure of a time interval in-between pulses in a periodic pulse repetition sequence, or a measure of an average time duration in-between pulses in case the pulse generation is more random. The more frequently pulses are generated the higher the pulse repetition frequency and vice versa. Pulse repetition frequency is a measure of the expected number of pulses generated by the system in a given time interval. The pulse repetition frequency may initially be configured according to a default pulse repetition frequency at start-up of the dust extractor, or as the latest used pulse repetition frequency.

The control unit 170 is arranged to determine a particle load level associated with the filter 125. The particle load level is indicative of how much particulate matter that has built up on the filter wall where it obstructs the air flow through the filter. The control unit 170 may for instance be arranged to obtain a differential pressure measurement ΔP over the pre-filter 125, and to determine the particle load level based on the differential pressure measurement ΔP=P1−P2, where P1 is a pressure measured upstream of the pre-filter and P2 is a pressure measured downstream of the pre-filter, as illustrated in FIG. 2.

The particle load level is preferably determined based on system pressure measurements in dependence of an air flow through the system since air flow and pressure measurements in the system are connected. The control unit 170 may also be arranged to obtain a downstream pressure measurement P3, P4 associated with an air pressure downstream from the pre-filter 125, and to determine the particle load level based on the upstream pressure measurement P3, P4 relative to atmospheric pressure or to some other reference pressure. This type of downstream pressure measurement may provide less accurate particle load information, especially if the measurement is taken downstream also from the essential filter 150, i.e., P4 in FIG. 2, since this pressure measurement value will also be affected by the particle load of the essential filter 150. Downstream pressure measurements (P3 and/or P4) relative to atmospheric pressure or to some other reference pressure can be used as back-up in case pressure measurements related to the pressure at, e.g., P1 is not available, or in system which do not comprise the necessary hardware to measure pressure at P1. To reduce variation in the pressure measurements, the control unit 170 can be arranged to determine the particle load level based on an average pressure measurement associated with the filter 125 over an averaging time period. The control unit 170 may, e.g., compute a moving average pressure value over a time period of 10-20 seconds or so. The bandwidth of this low-pass filtering, i.e., the amount of averaging, can be dynamically adjusted so as to obtain a measurement variance or sample standard deviation below a pre-determined variance threshold.

The control unit 170 preferably determines the pulse repetition frequency as an increasing function of the particle load level. An increasing function is here a function which assumes a small value for low particle loads and a higher value for higher particle loads. The increasing function may be just a step function, where a small or even a zero pulse repetition frequency is configured for particle load levels below a pre-determined filter cleaning activation threshold, and a higher pulse repetition frequency value is configured for particle load levels above the pre-determined filter cleaning activation threshold. However, improved performance is normally obtained if the pulse repetition frequency is gradually increased in more than one step, or as a piece-wise continuous and increasing function of a range of particle load levels.

The insert graph 302 in FIG. 3 illustrates an example of the above where the control unit 170 is arranged to configure a zero pulse repetition frequency 340 in case the particle load level is below a pre-determined filter cleaning activation threshold Th1. The control unit 170 is in this case also arranged to limit the pulse repetition frequency to be below a pre-determined maximum pulse repetition frequency 350, which in this example is configured whenever the particle load level exceeds a high load level Th2. Between the two threshold Th1 and Th2 an increasing function of particle load level is used to control the pulse repetition frequency, such as a linear function 360 or a second order polynomial function 370. The pulse repetition frequency may, generally, be configured as an increasing polynomial function 360, 370 over a pre-determined range of particle load levels Th1, Th2 as illustrated in the example 302. For example, the increasing function of the particle load level can be configured according to

$$f ( x ) = {\sum }_{i = 0}^{N} {a}_{i} {x}^{i}$$

where x is the particle load level, for instance a measured pressure drop (P1-P2) over the pre-filter 125, f(x) is the pulse repetition frequency, N is the order of the polynomial function, and

$${\{ {a}_{i} \}}_{i = 0}^{N}$$

are coefficients that determine the polynomial function.

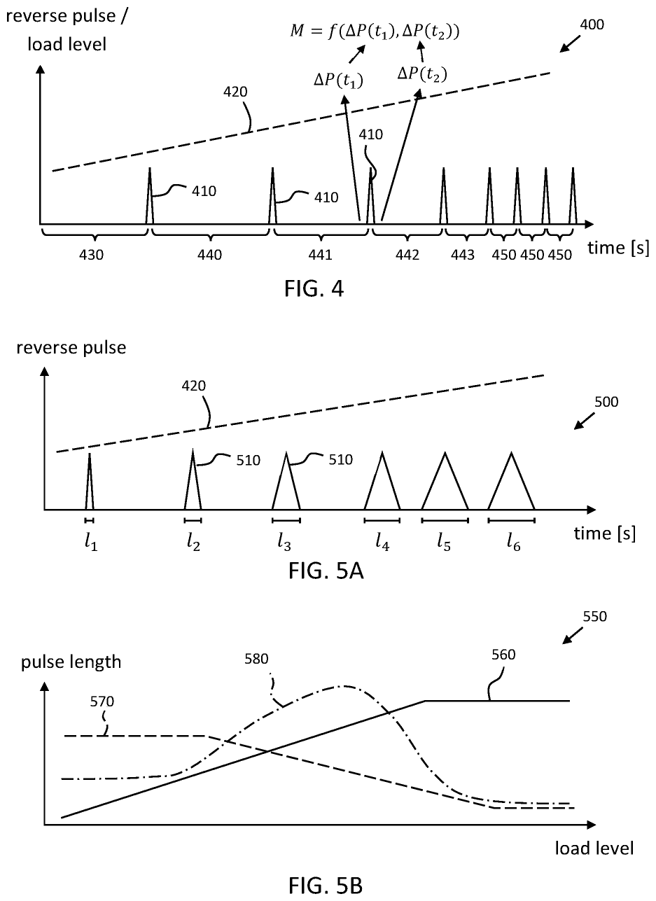

FIG. 4 illustrates an example 400 where reverse thrusts of air 410 through the pre-filter are generated as the particle load level 420 increases over time, i.e., as the pre-filter 125 becomes more and more particle laden over time. At first, during the initial time period 430, there are no pulses generated since the particle load level 420 is not high enough to warrant any filter cleaning. A relatively low pulse repetition frequency is then configured, which increases as function of the particle load level 420. This is illustrated in FIG. 4 by decreasing time periods 440, 441, 442, 443, in-between pulses 410. A maximum pulse repetition frequency is finally configured, where the time interval in-between pulses 410 is fixed at a small value 450. In this case the particle load level is advantageously measured as a pressure drop in the system over one or more filters and in dependence of an air flow through the system. The particle load level is preferably also determined based on a nominal filter characteristic determined by the control unit 170 based on a sweep over a range of air flows, as will be discussed in more detail below.

The control unit 170 is optionally also arranged to control a time duration {l₁l₂, . . . } of each reverse pulse of air 510 as a pre-determined (increasing) function of the particle load level. This is illustrated in FIG. 5A, where the time duration of generated air pulses increases over time with an increasing particle load level 420. An increased time duration of the reverse thrust of air is often more powerful in cleaning the filter, at least in some dust extractors, but also reduces dust extraction performance more than a short reverse thrust of air. A maximum time duration of the air cleaning pulse is preferably configured, since a too long reverse thrust of air will be less effective again, i.e., the effectiveness of a reverse thrust of air in cleaning the pre-filter will be an increasing function of pulse time length up to a point, where the effectiveness will again begin to drop down to a lower level. Hence, configuring a too long duration reverse thrust of air is not effective and should be avoided. The time duration of the thrust can optionally be configured in the same manner as the pulse repetition frequency discussed above. I.e., a minimum time duration can be specified which is used for low particle loads. The time duration of the pulse can then be increased as function of the particle load, according to a linear function of the particle load or some polynomial function of the particle load up to a pre-determined maximum pulse duration which is not to be exceeded regardless of particle load level in the system.

Other configurations of the pulse time duration may also be used with advantage. FIG. 5B illustrates some examples 550 where the time duration of each reverse pulse of air 510 is configured as pre-determined functions of the particle load level. These functions may be tabulated in a look-up table and used by the control unit 170 to control pulse duration. The function illustrated by the solid line 560 is an increasing function of the particle load level which saturates at a configurable particle load level. The function illustrated by the dashed line 570 instead configures shorter pulses as the particle load level increases. This type of function could, e.g., be used if the pulse rate is sharply increased, such that a high number of short duration pulses is used to loosen dust at very high particle load levels. Note that this decreasing function starts from a first constant time duration level and then gradually decreases to a second constant time duration level below the first constant time duration level. The function illustrated by the dash-dotted line 580 is a function which first increases and then decreases according to a polynomial function. This type of more general function may be found to give good results in some situations, often when pulse repetition frequency is controlled over a wide range of frequencies.

According to some aspects, the control unit 170 is arranged to determine a first particle load level within a pre-determined time period before a generated reverse pulse of air 310, 410, 510 and a second particle load level within a pre-determined time period after a generated reverse pulse of air 310, 410, 510. The control unit 170 may then determine a cleaning efficiency metric M based on the difference between the first particle load level and the second particle load level. By monitoring the change in particle load level before and after a filter cleaning operation involving at least one reverse thrust of air, the control unit 170 can determine if the filter cleaning operation is useful or if no effect is obtained on particle load level from the reverse thrust of air. In the example of FIG. 4 a first particle load level is determined as a pressure drop over the pre-filter ΔP(t₁) at time t₁ and a second particle load level ΔP(t₂) is determined in the same manner at time t₂. The change in pressure drop can be taken as an indication of whether the air pulse 410 had any effect on the particle load level. In other words, an efficiency metric M to quantify the effect of performing a filter cleaning operation can be formulated as a function of the first and second particle load levels, M=f(ΔP(t₁),ΔP(t₂)), e.g., by computing the difference M=ΔP(t₁)−ΔP(t₁).

In case the effect was significant, e.g., if the metric M is larger than an efficiency metric threshold, then the pulse repetition frequency can be increased in an attempt to improve the efficiency of the dust extraction operation further. However, if no significant change is detected in the particle load level before and after the cleaning operation, such as if the metric M is smaller than the efficiency metric threshold, then it may not be useful to increase the pulse repetition frequency further. In fact, a decrease in pulse repetition frequency may be justified, at least to a point where an improvement in particle load is again seen as a result of the filter cleaning operation. Thus, according to some aspects the control unit 170 is arranged to configure the pulse repetition frequency as an increasing function of the cleaning efficiency metric.

The control unit 170 is optionally arranged to trigger a super-clean procedure in response to the cleaning efficiency metric breaching a super-clean trigger threshold. A super-clean procedure may comprise blocking an inlet 110 of the dust extractor 100 and triggering generation of a series of reverse pulses of air 310, 410, 510 for cleaning the pre-filter 125. Blocking the inlet 110 of the dust extractor 100 may comprise issuing an instruction to a user to manually block the inlet 110 or controlling the above-mentioned automatic inlet blocking device of the dust extractor 100 to block the inlet 110.

A problem when configuring various detection criteria by a control unit 170 in a dust extractor 100, such as thresholds for detecting missing or malfunctioning filters based on measurements of pressure in a dust extraction system, and pre-filter cleaning operation triggering criteria, is that the absolute pressure levels in the system and also the difference in pressure at various places in the system changes with air flow. Moreover, the relationship between air flow and pressures in the system changes with the properties of the dust extractor and the filters used in the dust extractor. Thus, if a new type of filter, perhaps in a different material or having a different geometry is used as replacement for an old filter, then the relationship between system pressures and air flow in the dust extraction system may change. Hence, a configured set of detection criteria for, e.g., missing filters, malfunctioning filters, or particle-laden filters may become obsolete.

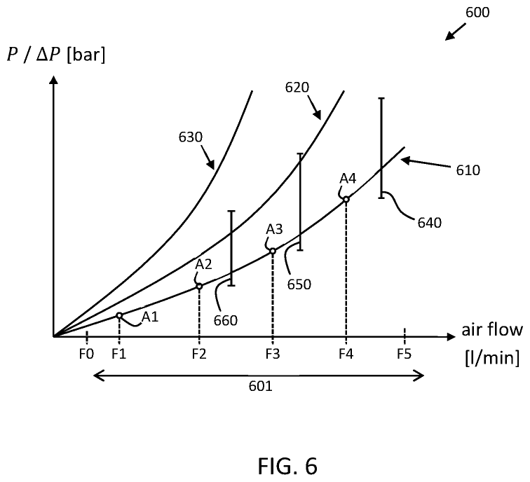

FIG. 6 illustrates an example nominal relationship 610 between system pressure drop and air flow. The system pressure drop may be an absolute pressure P in the dust extraction system measured relative to atmospheric pressure, such as an air pressure downstream of the essential filter 150 (P4 in FIG. 2) relative to atmospheric pressure. The system pressure drop may also be a pressure difference ΔP measured over the pre-filter (P1−P2 in FIG. 2), or a pressure difference measured over the essential filter 150 (P3−P4 in FIG. 2). This relationship between air flow and system pressure drop is normally modelled accurately by a second order polynomial or by a linear of affine function.

In case the control unit 170 has knowledge of the nominal relationship between air flow and system pressure drop for the dust extractor 100, i.e., with a fresh set of filters without particle load or malfunction, it can configure system specific thresholds and other detection and control criteria based on this nominal relationship without need for manual configuration or software updates when something in the system changes, such as if a new type of filter is used, or updates are made to the geometry of the dust extractor 100, such as a change in geometry of the cyclone 120, the filter holders 155, or the air conduits 140 in the dust extraction system.

The relationship between air flow and system pressure drop at various places in the dust extraction system then changes as the filters are used. FIG. 6 illustrates two examples of current relationships which can be seen after some time period of filter use. The example curve 620 is representative of a medium particle load, while the example curve 630 shows an example of what a system with high particle load may look like. Note how the system pressure drop in the system increases with particle load, i.e. how the vacuum builds faster in the system with increasing air flow if the filters are particle laden compared to when the filters are new and not particle lades.

FIG. 6 exemplifies some detection criteria 640, 650, 660. These spans are representative of acceptable variation in system pressure drop for a given air flow value. If the system pressure deviates beyond these ranges a malfunction may be declared. In case the system pressure drop goes below the acceptable span then a missing filter or damaged filter detection can be made, while if the system pressure goes above the span a particle-laden filter can be suspected.

The size of the spans 640, 650, 660 can be configured as a function of air flow, such as that a smaller air flow value corresponds to a more narrow span of acceptable pressure drop values compared to a higher air flow. For instance, an upper limit T_{high} of a span 640, 650, 660 can be configured as

$${T}_{high} = N ( x ) * α$$

where N(x) is the value of a nominal relationship between air flow and system pressure drop for the dust extractor 100 evaluated at a current air flow x, and α>1 is a pre-determined scaling factor which can be determined by laboratory experimentation or computer simulation. An upper limit T_{high} of a span 640, 650, 660 can also be configured as

$${T}_{high} = N ( x ) + β ( x )$$

where again N(x) is the value of the nominal relationship between air flow and system pressure drop for the dust extractor 100 evaluated at a current air flow x, and β(x)>0 is a pre-determined margin value which can be determined by laboratory experimentation or computer simulation. The margin value can optionally be defined as a function of air flow x. Both scaling by α and biasing by β can be used at the same time. A lower limit T_{low} of a span 640, 650, 660 can be configured in a similar manner as

$${T}_{low} = N ( x ) * {α}^{′} + {β}^{′} ( x )$$

where N(x) is the value of the nominal relationship between air flow and system pressure drop for the dust extractor 100 evaluated at an air flow x. The scaling and margins α′<1 and β′(x)<0 are again pre-determined from computer simulation or laboratory experimentation.

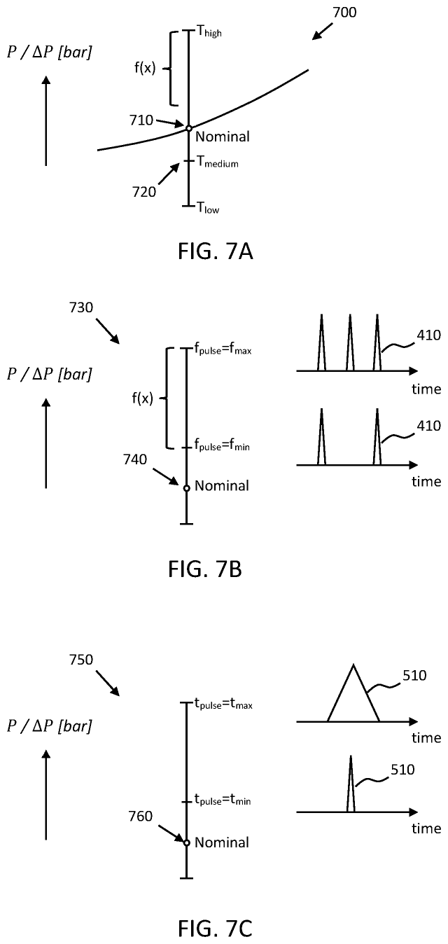

FIG. 7A illustrates an example span 700 delimited by a high threshold value T_{high} and a low threshold value T_{low}. The limits are defined in relation to a nominal value 710 determined by the control unit 170 using a variable air flow of the dust extractor 100, as discussed above in connection to FIG. 6. The high threshold value T_{high} can for instance be used to trigger a pre-filter cleaning operation or suggest filter replacement. The low threshold value T_{low} may be used to detect a missing filter. FIG. 7A also illustrates an intermediate point 720 in the span defined in relation to the nominal value 710. This type of intermediate point can be used to, e.g., detect a damaged filter. An upper range of the span in FIG. 7A can be used to determine a pulse repetition frequency f(x) as discussed above.

FIG. 7B illustrates another example span 730, determined in dependence of a nominal relationship 740 between air flow and system pressure drop for the dust extractor 100 evaluated at a current air flow x. In this case the span 730 is used to dynamically configure a pulse repetition frequency, from a minimum frequency some margin above the nominal relationship value up to a maximum pulse repetition frequency. The pulse repetition frequency f(x) can be a step function, a linear function of particle load level, or some polynomial function of particle load level, where the particle load level is then determined from system pressure measurements in relation to the nominal relationship 740 between air flow and system pressure drop for the dust extractor 100. This way the characteristics of the dust extractor system is taken into account when determining the different operating parameters of the dust extractor 100. FIG. 7C illustrates another example span 750, determined in dependence of a nominal relationship 760 between air flow and system pressure drop for the dust extractor 100 evaluated at a current air flow x. This time the cleaning pulse time duration is the operating parameter of the dust extractor 100 that is configured. A short duration pulse is configured if the system pressure drop over, e.g., the pre-filter, is close to the nominal value, while a longer pulse duration is used if the pressure drop over the filter is further from the nominal value. Once more the characteristics of the dust extractor system is taken into account when determining the different operating parameters of the dust extractor 100, which is an advantage.

To summarize, it has been realized that if the dust extractor 100 comprises a blower system 160 arranged to generate a variable air flow 601 through one or more filters 125, 150 of the dust extractor 100, then the control unit 170 can be arranged to configure at least a first air flow F1, F2, F3, F4 and a second air flow F2, F3, F4 by the blower system 160, and also to obtain an air pressure measurement A1, A2, A3, A4 for each configured air flow, as illustrated in FIG. 6, where the air pressure measurement is indicative of an air pressure drop P/ΔP across at least one of the filters 125, 150 of the dust extractor 100. The control unit 170 may then determine a nominal relationship 610 between air pressure and air flow based on the obtained air pressure measurements and configure at least one operating parameter of the dust extractor 100 based on the nominal relationship between air pressure and air flow.

In other words, the control unit 170 can use the variable air flow blower to “sweep” air flow and measure pressure drop as function of the air flow. This way the control unit can characterize the present filtering characteristics of the dust extractor and configure various operating parameters of the dust extractor based on the determined nominal relationship between air flow and system pressure drop. The control unit 170 may for instance determine the nominal relationship 610 between air pressure and air flow by fitting a polynomial function to the configured air flows and corresponding air pressure measurements.

The at least one operating parameter of the dust extractor 100 configured by the control unit 170 based on the nominal relationship 610 between air pressure and air flow may comprise any of; a missing filter detection criterion, a damaged filter detection criterion, and a particle-laden filter detection criterion, as discussed above, e.g., in connection to FIG. 7A. The control unit may also use the determined nominal relationship 610 between air pressure and air flow to configure a pulse repetition frequency and/or pulse time duration as exemplified in FIG. 7B and in FIG. 7C respectively, for cleaning one or more pre-filters of the dust extractors.

According to some aspects, the control unit 170 is also arranged to determine a current relationship 620, 630 between air pressure and air flow based on a repeated set of obtained air pressure measurements versus air flow, and to compare the current relationship 620, 630 to the nominal relationship 610. The control unit 170 may then determine a current filter state based on a difference between the current and nominal relationships between air pressure and air flow. The difference D between current and nominal relationships as function of air flow x can, e.g., be determined as

$$D = {\int }_{xmin}^{xmax} ( {R}_{current} ( x ) - {R}_{nominal} ( x ) ) dx$$

where R_{current}(x) and Rₙₒₘᵢₙₐₗ(x) are the current and nominal relationships as function of air flow x, compared between a low air flow level xmin and a high airflow level xmax.

The difference D can also be determined by comparing a set of N discrete values, i.e.,

$$D = {\sum }_{i = 0}^{N} {w}_{i} ( {R}_{current} [ {x}_{i} ] - {R}_{nominal} [ {x}_{i} ] )$$

where an optional weighting factor wᵢ has also been added to emphasize more important samples, e.g., samples around the mid-point of a span, and de-emphasize samples taken towards the minimum and maximum air flow values. The control unit 170 can for instance be arranged to configure the first and second air flows F1, F2, F3, F4 in response to a filter characterization trigger signal, which may be triggered in connection to a filter replacement operation. Thus, every time a new filter is inserted into the dust extractor 100, a filter characterization is performed. This way any changes in filter specification, such as its material properties or geometry, will be automatically accounted for in the control of the dust extractor.

According to some aspects, the control unit 170 is arranged to configure air flow F1, F2, F3, F4 by the blower system 160 based on a configured fan speed or drawn motor power of the blower system and on a predetermined relationship between fan speed or motor power and air flow through the one or more filters 125, 150 of the dust extractor 100.

According to some other aspects, the control unit 170 is arranged to configure air flow F1, F2, F3, F4 by the blower system 160 based on a measured air flow through the one or more filters 125, 150 of the dust extractor 100, where the measured air flow is obtained from any of an anemometer flow meter arrangement, a pitot pipe flow meter arrangement, and/or a venturi flow meter arrangement.

The control unit 170 may of course also obtain air flow measurement from one or more air flow sensors as discussed above and adjust a fan speed or fan motor power in dependence of the measured air flow to obtain a desired air flow through the dust extractor system.

In most cases it is sufficient to characterize the dust extractor filters, i.e., the relationship between air flow and system pressure drop in the system using only two values of air flow and corresponding system pressure drop measurement. However, the control unit 170 can also be arranged to sweep the variable air flow 601 from a low airflow level F0 to a high air flow level F5 and monitor the air pressure measurement value during the variable air flow sweep. This gives a more accurate representation of the relationship between air flow and system pressure drop. In fact, if enough measurement points are used no functional fit is necessary since the relationship is anyway sampled with enough points to be representative of the relationship between air flow and system pressure drop. A linear interpolation between measurement points may be used also.

The control unit 170 is preferably arranged to obtain each air pressure measurement after a pre-determined settling time duration while holding the configured air flow at a constant value. This reduces the impact from transient system pressure variation as a consequence of the changes in air flow, thereby giving more reliable system pressure measurement data. An amount of averaging during the acquisition of air pressure measurement data is also preferred. The amount of averaging may be determined based on a variance or deviation of the measured system pressure values and/or system pressure difference values, so as to be below a pre-determined level.

The control unit 170 may, as noted above, be arranged to obtain each air pressure measurement as a differential pressure measurement ΔP over a pre-filter 125 and/or over an essential filter 150 of the dust extractor 100. Thus, the filter characterization can be made separately for the pre-filter 125, separately for the essential filter 150, and/or for the joint filtering function comprising both pre-filter and essential filter. It is also noted that some dust extractors comprise more than one pre-filter and/or more than one essential filters. Such multi-filter systems can also be characterized in this manner.

The control unit 170 may furthermore by arranged to obtain each air pressure measurement as a downstream pressure measurement P3, P4 associated with an air pressure downstream from the pre-filter 125 or downstream from the essential filter 150 of the dust extractor 100.

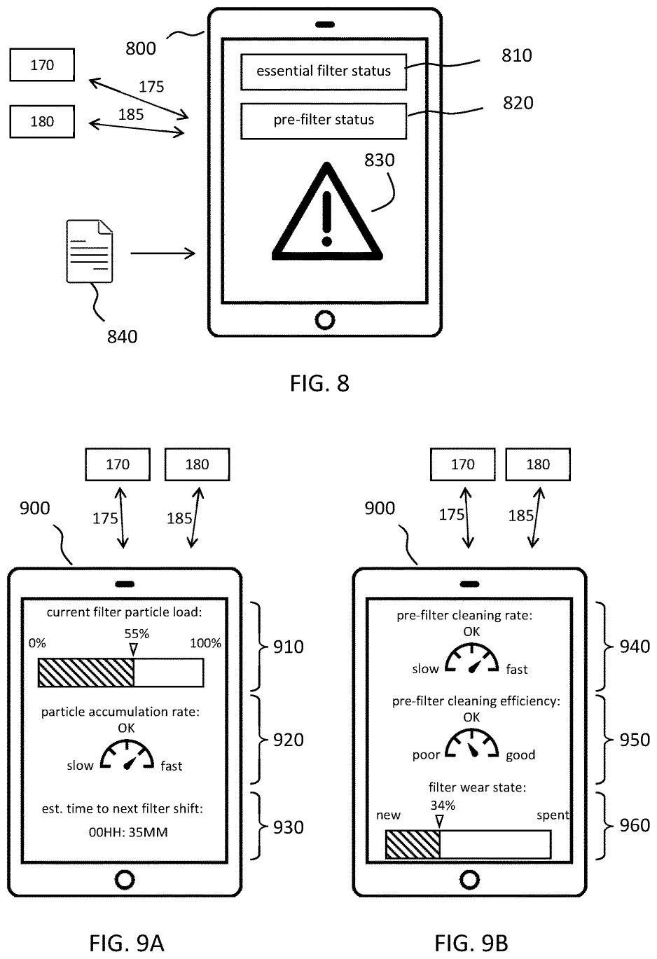

FIGS. 8, 9A and 9B illustrate various display devices 800, 900 which can be used together with the dust extractor 100, and/or with the server 180 illustrated in FIG. 1A to monitor and control a single dust extractor 100 or a fleet of dust extractors.

FIG. 8 illustrates a display device 800 which is configured to display an essential filter status 810 and a pre-filter status 820, as well as notifications and warnings 830 indicating various malfunctions of the dust extractor. The display device 800 may also be arranged to receive various types of configuration data 840, e.g., automatically from the server 180 or by manual configuration.

The essential filter status 810 and the pre-filter status 820 may comprise information regarding missing filter detection status and malfunctioning filter detection status. These statuses may be determined based on the nominal filter characteristics as discussed above.

FIG. 9A exemplifies displays of current filter particle load 910 which can be made more accurate if nominal filter characteristics are accounted for as discussed above. A particle accumulation rate 920 associated with any of the pre-filter or the essential filter of the dust extractor can also be displayed, as well as an estimated time to next filter replacement or servicing. The data items 910, 920, and 930 can be displayed separately for any number of pre-filters and essential filters of a dust extractor.

FIG. 9B exemplifies displays of pre-filter cleaning rate 940, pre-filter cleaning efficiency 950 and filter wear state 960. The pre-filter cleaning rate 940 may be set up to show the current pulse repetition frequency of the pre-filter cleaning system, i.e., how often the pre-filter is subject to reverse thrusts of air to remove particulate matter which has become adhered to the pre-filter walls.

The control unit 170 can be arranged to display the cleaning efficiency metric discussed above. The pre-filter cleaning efficiency 950 can be configured in dependence of a measured particle load level before and after a filter cleaning operation, i.e., just before a reverse thrust of air is pushed through the pre-filter and just after the reverse thrust of air. By this display device a user can obtain information regarding the efficiency of the filter cleaning operation. If the efficiency suddenly drops, then a manual inspection of filter state may be warranted, and perhaps a filter replacement or filter servicing is advisable.

The control unit 170 is optionally arranged to update a filter cleaning counter each time a reverse pulse of air 310, 410, 510 for cleaning the pre-filter 125 is triggered. A pre-filter wear state can then be determined based on the value of the filter cleaning counter, and optionally displayed on a display unit 900. This filter wear state indicator 960 may for instance be configured 840 with an approximate number of filter cleaning operations before the pre-filter is considered spent. The control unit 170 may also be arranged to trigger generation of a notification message 830 in case the value of the filter cleaning counter exceeds a pulse counter threshold.

A fleet management system is also disclosed herein which comprises a server 180 operatively connected to a database 185 for managing a plurality of dust extractors 100 according to the discussion above. The server 180 is arranged to obtain data related to one or more filter arrangements comprised in the dust extractors 100 and to maintain an information record in the database 185 for each of the one or more filter arrangements, and to schedule a filter maintenance operation or a filter replacement operation based on the maintained information records.

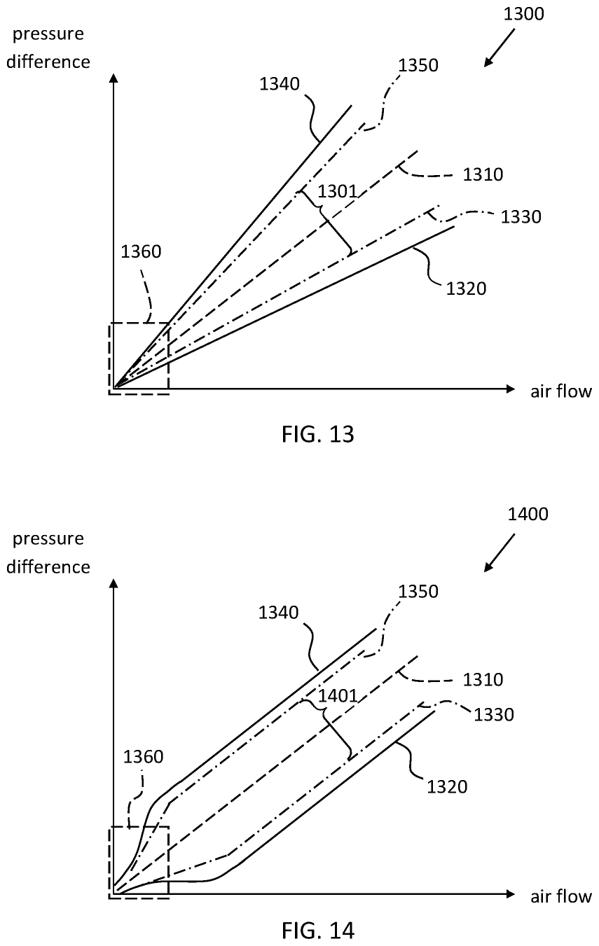

FIG. 13 and FIG. 14 illustrate some detection principles based on measured pressure difference over a filter versus air flow through the filter. The examples 1300, 1400 illustrate thresholds generated according to the principles discussed above in connection to, e.g., FIG. 6 and FIGS. 7A-C. The nominal operating characteristic 1310 of the system (determined, e.g., by sweeping air flow and monitoring pressure drops as discussed above) is a pressure drop value as function of air flow. The relationship between pressure drop over a filter or part of the dust extraction system and air flow through the filter or sub-system may be a function of filter type, filter dimension, and possibly also environmental factors such as ambient humidity and height over sea level. The geometry of the dust extraction system, i.e., air channel shape and size also plays a role.

Suppose, as discussed above, that the pressure drop over a filter or part of the dust extraction system can be modelled as

$$Δ p = k {x}_{flow} + m$$

where Δp is the pressure drop, k is a proportionality constant, and m is a constant bias, then the test statistic

$$T = \frac{Δ p - m}{{x}_{flow}} = k$$

is at least approximately constant over different air flow levels. This test statistic T can then be compared against various detection criteria, as discussed above.

FIGS. 13 and 14 illustrate some example thresholds 1320, 1330, 1340, 1350 which vary with air flow through a filter, i.e., configurable operating parameters of a dust extractor. The thresholds are linear or piecewise linear functions in this example. In both examples 1300, 1400, a missing filter threshold 1320 and/or a filter malfunction threshold 1330 is configured in dependence of an air flow through the filter. If the air pressure drop across a filter goes below these thresholds, it is deemed that no fully functional filter is installed (since the pressure drop is too small). The actual values of the pressure drop that is to be expected for a given filter and dust extractor varies, and hence it is an advantage that the detection functions are configured based on a determined nominal relationship 1310 between air pressure and air flow determined from obtained air pressure measurements during a sweep of air flow through the system, as discussed above.

The functions of air flow in both examples define an operating region 1301, 1401 around the nominal operating characteristic. As long as the pressure difference is within this region, the filter is deemed to be fully operational, and no warning is triggered. However, if the pressure difference measured across the filter drops below the threshold 1320, then a missing filter condition is detected. If the pressure difference drops below the threshold 1330, then a malfunctioning filter condition is detected. It is appreciated that the filter malfunction feature can be implemented independently of the missing filter feature. In other words, a dust extractor may comprise a filter malfunction detection function but no missing filter detection function, and vice versa. A too large pressure difference may instead indicate a particle laden filter in need of replacement or cleaning. The control unit 170 is therefore optionally arranged to detect a particle-laden essential filter if the pressure difference is above a configurable first particle-laden filter threshold 1350 or a second particle-laden filter threshold 1340. The larger of the two, i.e., the second particle-laden filter threshold 1340 may be used as an indication that the filtering function is no longer acceptable for dust extraction to be performed using the filter. The thresholds 1340, 1350 can be used to control a filter cleaning function in terms of pulse repetition frequency, pulse time duration, or the triggering of a super-clean operation.

In some cases, reliable detection may be difficult to achieve when air flow through a filter (such as the pre-filter 125 or the essential filter 150) is very small. To avoided false detections, the control unit 170 may optionally be arranged to inactivate missing filter detection, malfunctioning filter detection and/or particle-laden filter detection in case the air flow through the filter 125, 150 is below a configurable minimum limit value 1360. Detection of particle-laden filter conditions may also be inactivated when the dust extractor is operating in this region of air flow. The control unit may be configured to freeze operating parameters of the dust extractor in case the dust extractor is operating in the low flow region 1360, i.e., to not configure any operating parameters of the dust extractor 100 based on the nominal relationship between air pressure and air flow in case the air flow is in a low air flow region 1360.

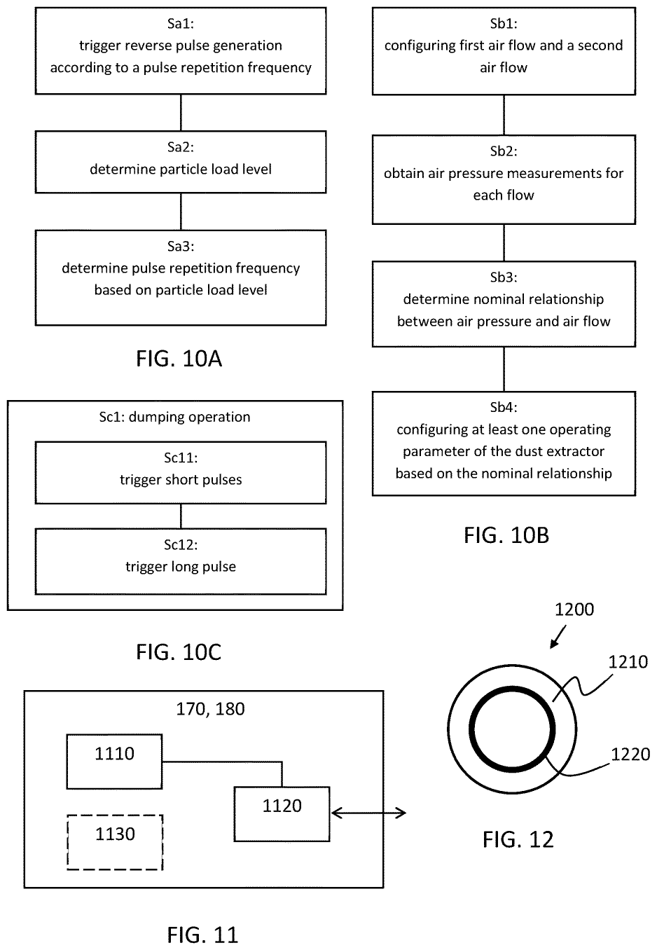

FIGS. 10A and 10B are flow charts illustrating methods which summarize the above discussion. The different technical features discussed above give rise, in use, to variants and extensions of the methods illustrated in FIGS. 10A and 10B. Hence, it is appreciated that all the technical features discussed herein can also be formulated as methods.

FIG. 10A shows a method performed by a control unit 170 in a heavy duty dust extractor 100, the method comprising
triggering Sa1 generation of reverse pulses of air 310, 410, 510 for cleaning a pre-filter 125 of the dust extractor 100 according to a pulse repetition frequency 320,
determining Sa2 a particle load level associated with the filter 125, and
determining Sa3 the pulse repetition frequency as an increasing function of the particle load level.

FIG. 10B shows a method performed by a control unit 170 in a heavy duty dust extractor 100, where the dust extractor 100 comprises a blower system 160 arranged to generate a variable air flow 601 through one or more filters 125, 150 of the dust extractor 100, the method comprising
configuring Sb1 at least a first air flow F1, F2, F3, F4 and a second air flow F2, F3, F4 by the blower system 160,
obtaining Sb2 an air pressure measurement A1, A2, A3, A4 for each configured air flow, where the air pressure measurement is indicative of an air pressure drop P/ΔP across at least one of the filters 125, 150 of the dust extractor 100,
determining Sb3 a nominal relationship 610 between air pressure and air flow based on the obtained air pressure measurements, and
configuring Sb4 at least one operating parameter of the dust extractor 100 based on the nominal relationship between air pressure and air flow.

FIG. 11 schematically illustrates, in terms of a number of functional units, the general components of a control unit 170 or a server 180. Processing circuitry 1110 is provided using any combination of one or more of a suitable central processing unit CPU, multiprocessor, microcontroller, digital signal processor DSP, etc., capable of executing software instructions stored in a computer program product, e.g. in the form of a storage medium 1130. The processing circuitry 1110 may further be provided as at least one application specific integrated circuit ASIC, or field programmable gate array FPGA.

Particularly, the processing circuitry 1110 is configured to cause the device 170, 180 to perform a set of operations, or steps, such as the methods discussed in connection to FIGS. 10A-B and the discussions above. For example, the storage medium 1130 may store the set of operations, and the processing circuitry 1110 may be configured to retrieve the set of operations from the storage medium 1130 to cause the device to perform the set of operations. The set of operations may be provided as a set of executable instructions. Thus, the processing circuitry 1110 is thereby arranged to execute methods as herein disclosed.

The storage medium 1130 may also comprise persistent storage, which, for example, can be any single one or combination of magnetic memory, optical memory, solid state memory or even remotely mounted memory.

The device 170, 180 may further comprise an interface 1120 for communications 175, 185 with at least one external device. As such the interface 1120 may comprise one or more transmitters and receivers, comprising analogue and digital components and a suitable number of ports for wireline or wireless communication.

The processing circuitry 1110 controls the general operation of the control unit 170 or the server 180, e.g., by sending data and control signals to the interface 1120 and the storage medium 1130, by receiving data and reports from the interface 1120, and by retrieving data and instructions from the storage medium 1130.

FIG. 12 illustrates a computer readable medium 1210 carrying a computer program comprising program code means 1220 for performing the methods illustrated in FIGS. 10A-B and/or for executing the various functions discussed above, when said program product is run on a computer. The computer readable medium and the code means may together form a computer program product 1200.

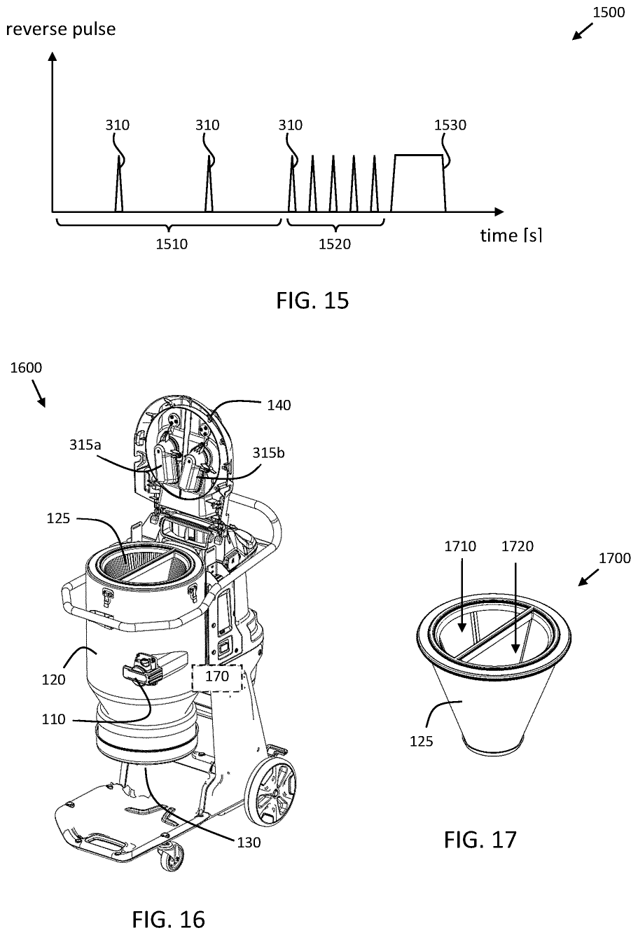

FIG. 15 illustrates a dumping operation for evacuating dust from a cyclone. As mentioned above, dust accumulates in the cyclone 120 during operation of a heavy-duty vacuum cleaner such as that illustrated in FIG. 1 and in FIG. 16. The cyclone 120 normally comprises a pre-filter 125 for separating out larger debris particles from the particle-laden airflow entering the inlet 110. The larger debris particles trapped by the cyclone 120 may be collected via an outlet 130 of the cyclone 120, e.g., in a disposable plastic bag, such as a Longopac dust container system, or other dust container (not shown in FIG. 1 nor in FIG. 16).

A hatch or other form of closing mechanism is normally arranged at the outlet 130 to prevent the disposable plastic bag from being sucked into the cyclone during operation, and also to promote the cyclone action inside the cyclone 120 during operation.

A dumping operation is when dust accumulated inside the cyclone 120 is evacuated into the dust container below the cyclone 120. Dumping operations may be automatic, e.g., triggered by the weight of the accumulated dust inside the cyclone 120, manually triggered by an operator, or automatic. A problem that may occur during dumping operations is that the dust has settled inside the tank to form a solid cake, which can be hard to evacuate from the cyclone 120.

To promote more efficient dumping, it is proposed herein to use the valve arrangement 315 that generates the reverse pulse of air 310 to agitate or unsettle the accumulated dust in preparation for dumping.

FIG. 15 illustrates an example of this type of dumping operation. The control unit 170 is here arranged to trigger generation of reverse pulses of air 310 for cleaning a filter 125 of the dust extractor 100 by opening and closing a valve arrangement 315. The filter cleaning is initially performed as discussed above, i.e., by a pulse train of reverse pulse of air 1510 at some pulse repetition frequency which may or may not be an increasing function of the particle load level. A dumping operation is then triggered. The dumping operation comprises generation of a compact sequence of short reverse pulses of air 1520 followed by a longer reverse pulse of air 1530. The control unit 170 uses the reverse pulses of air to generate movement in the accumulated dust, which unsettles it. The dust, once unsettled, becomes more easy to evacuate from the cyclone 120 by opening up the valve arrangement to generate a longer reverse burst of air 1530.

FIG. 16 shows an example heavy-duty dust extractor 1600 which comprises dual pre-filters. In this case the pre-filter 125 is a split filter which has two separate compartments. Each such compartment can be cleaned separately from the other compartment, by generation of reverse thrusts of air into the clean side of the filter. Having a split filter in this manner is an advantage since dust extraction can continue during filter cleaning since the two filter compartments are not cleaned at the same time.

The example dust extractor 1600 comprises a first valve arrangement 315a and a second valve arrangement 316b. Each valve arrangement opens up a passage between the clean side of its respective filter compartment and the ambient environment, where there is atmospheric pressure. The control unit 170 can control the two valve arrangements to clean the two compartments according to a cleaning pattern.

FIG. 17 illustrates an example split pre-filter 125, 1700, having a first compartment 1710 and a second compartment 1720.

It is appreciated that the same technical effect can be obtained if instead two separate filters are installed in the cyclone, such as two cylindrical pre-filters mounted side-by-side.

Consequently, the control unit 170 is arranged to control the first valve arrangement 315a and the second valve arrangement 315b. Each valve arrangement 315a, 315b opens and closes a passage between a clean side of a respective filter 125 of the dust extractor 100 and atmospheric pressure. A split filter can be used as exemplified in FIG. 16 and FIG. 17, or separate filters arranged in the same cyclone.

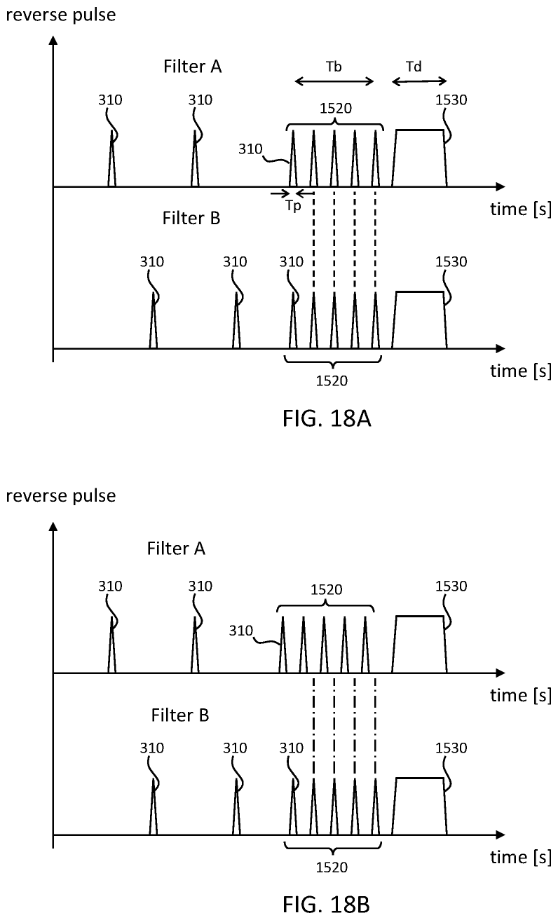

The control unit 170 is arranged to execute a dumping operation 1520, 1530 that comprises generation of compact sequences of short reverse pulses of air 1520 by the first valve arrangement 315a and by the second valve arrangement 315b, followed by a longer synchronized reverse pulse of air 1530 by the first valve arrangement 315a and by the second valve arrangement 315b, as exemplified by FIG. 18A and FIG. 18B.

FIG. 18A illustrates an example where the compact sequences of short reverse pulses of air 1520 by the first valve arrangement 315a and by the second valve arrangement 315b are aligned in time as illustrated by the dashed lines, while FIG. 18B illustrates an example where the compact sequences of short reverse pulses of air 1520 by the first valve arrangement 315a and by the second valve arrangement 315b are interleaved in time as illustrated by the dash-dotted lines.

It is appreciated that there are many ways to configure the compact sequences of short reverse pulses of air 1520 by the first valve arrangement 315a and by the second valve arrangement 315b. The sequences can be random in time, staggered in time, partly aligned, of slightly different frequencies, and so on, within the scope of the present disclosure.

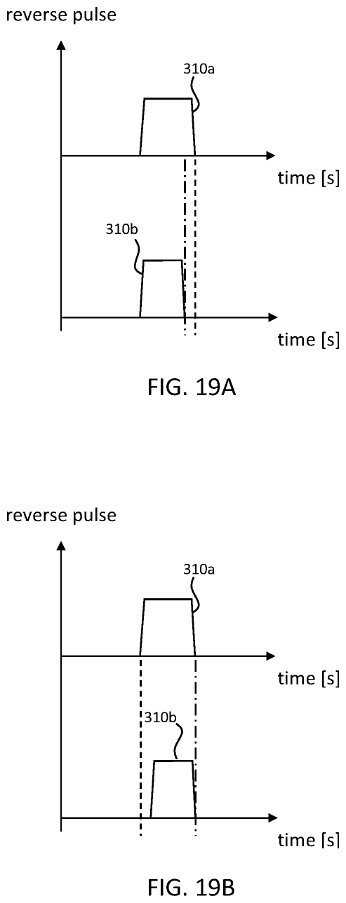

The reverse pulses of air can also be staggered in the sense that they start at the same time instant but end at slightly different time instants. FIGS. 19A-B illustrate two example of this type of configuration. The reverse pulse of air 310a used to clean the first filter by actuation of the first valve arrangement is slightly longer in time duration compared to the pulse of air 310b used to clean the second filter by actuation of the second valve arrangement, as indicated by the dashed and the dash-dotted lines in FIGS. 19A-B.

The short pulses of air in the compact sequence of short reverse pulses of air 1520 can be of a time duration Tp between 10-200 ms, and preferably 70-100 ms.

The longer reverse pulse of air 1530 can be of a time duration Td between 200-5000 ms, and preferably about 500 ms.

The time duration Tb of the compact sequence of short reverse pulses of air 1520 can be of a time duration in a range 200-1000 ms.

The time duration Tb of the compact sequence of short reverse pulses of air 1520 is preferably larger than the duration Td of the longer reverse pulse of air 1530.

The time duration Tb+Td of the dumping operation 1520, 1530 can be between 0.5-5s, and preferably about 1s.

It is appreciated that the compact sequence of short reverse pulses of air 1520 can be used without the longer reverse pulse of air 1530.

The time duration inbetween the short pulses 310 in the compact sequence of short reverse pulses of air 1520 can be between 10-200 ms, and preferably 70-100 ms. The time duration between the short pulses and the time duration of the short pulses are preferably configured within 20% of each other.

The compact sequence of air pulses can also be used in a dust extractor to generate a vibration of the cyclone 120, and also of other parts in the dust extractor. A vibration of the dust extractor can be beneficial in order to upset an amount of dust accumulated in the cyclone 120, so as to prevent the dust from setting into a solid cake which can be difficult to evacuate from the cyclone and into a dust contained arranged underneath the cyclone. This type of vibration can be triggered with advantage by the control unit 170 periodically, and/or in connection to certain events, such as shutting down the dust extractor. Consequently, there is disclosed herein a dust extractor 100, 1600 comprising a cyclone 120, a filter 125, a valve arrangement 315, 315a, 315b, and a control unit 170. The valve arrangement 315, 315a, 315b is arranged to open and close a passage between a clean side of the filter 125 of the dust extractor 100 and atmospheric pressure, as discussed above. The control unit 170 is arranged to control the valve arrangement 315, 315a, 315b to generate a vibration of the cyclone 120, by repeatedly opening and closing the valve arrangement 315, 315a, 315b according to a compact sequence of short reverse pulses of air, where the compact sequence of short reverse pulses of air comprises at least two short pulses in a time period of 200 ms. According to some aspects the compact sequence of short reverse pulses of air comprises at least three pulses of time duration no more than 100 ms each, and preferably about 75 ms each.

FIG. 10C illustrates a computer-implemented method performed by a control unit in a heavy duty dust extractor, where the control unit 170 is arranged to trigger generation of reverse pulses of air 310, 410, 510 for cleaning a filter 125 of the dust extractor 100 by opening and closing a valve arrangement 315, 315a, 315b as discussed herein. The method comprises executing Sc1 a dumping operation 1520, 1530, by triggering Sc11 generation of a compact sequence of short reverse pulses of air 1520, followed by triggering Sc12 generation of a longer reverse pulse of air 1530.

FIG. 20 and FIGS. 21A-B illustrate an example valve arrangement for cleaning dual pre-filters. This arrangement can be used with advantage to generate the reverse pulse of air discussed herein, and in particular the pulses used to clean the dual filter arrangement in the dust extractor 1600 shown in FIG. 16. FIG. 20 shows an example valve arrangement for a dust extractor 100, 1600 comprising the pre-filter 125. It is, however, also noted that the same valve arrangement can be used in a design with a plurality of separate pre-filters, such as two or more separate cylindrical pre-filters arranged in the same pre-separator tank.

In this arrangement, two separate valves are configured in respective parts of the pre-filter 125 to clean the filter parts. The spatially efficient configuration of the valves and the integrated suction conduits 2001 is particularly noted. Each valve arrangement 1250 is integrated in the lid of the dust extractor and extends into the dust extractor interior away from the lid plane. The suction conduits 2001 are formed at least partly in the pre-filter interior volumes V, thus saving overall dust extractor height.

Each valve arrangement 2000 is configured to generate a reverse flow of air to clean a respective part of the pre-filter 125. It is, however, appreciated that the valve arrangements can be used individually also, i.e., to clean pre-filter arrangements in dust extractors which only comprises a single pre-filter, or a pre-filter without a separating wall. Each of the valve arrangements 2000 exemplified in FIG. 20 comprises a main valve closure body 2010 arranged to move between a first position 2020 and a second position 2030, where, in the first position 2020, the main valve closure body 2010 is arranged to seal a passage 2040 between an ambient pressure P2 side and a low pressure P3 side of the valve arrangement 1250, and where, in the second position 2030, the main valve closure body 2010 is arranged to seal a passage between the low pressure P3 side of the valve arrangement 1250 and a suction conduit, P4. In this example the first position 2020 is associated with a seat 2015 against which the main valve closure body 2010 seals the passage 2040 between the ambient pressure P2 side and the low pressure P3 side of the valve arrangement 2000, while the second position 2030 is associated with a seat against which the main valve closure body 2010 seals the passage between the low pressure P3 side of the valve arrangement and the suction conduit. Note how the suction conduit is arranged at least partly inside the pre-filter interior, and how the seat for the main valve closure body is formed at the opening of the suction conduit, to form a space saving arrangement.

With reference to the example valve arrangement in FIGS. 21A-B, the suction conduit 2001 is arranged on a pre-filter side of the lid plane, i.e., the plane in which the dust extractor lid extends. The suction conduit comprises a seat against which the main valve closure body 2010 is arranged to seal the passage 450 between the low pressure P3 side of the valve arrangement and the suction conduit 2001. To seal the passage, the main valve closure body 2010 is moved downwards, away from the lid plane and towards the seat. Thus, the main valve closure body 2010 separates the seat from the lid plane and also from most other parts of the lid.

It is also noted that the suction conduit 2001 extends beyond an aperture plane of the pre-filter 125, i.e., into the pre-filter 125. This provides for a particularly efficient design in terms of building height, i.e., it is a space-conserving way to construct a lid for a heavy-duty dust extractor 100, 1600.

The valve arrangement 1250 also comprises a control body 2060, connected to the main valve closure body 2010, such that a position of the main valve closure body 2010 is determined by a position of the control body 2060. In other words, if the control body 2060 moves, so does the main valve closure body 2010. Note that this motion is vertical in the normal operating position, or normal with respect to a plane of the main valve closure body 2010, but this exact configuration is not strictly necessary for the arrangement to function.

The position of the main valve closure body 2010 can be determined by the position of the control body 2060 is many different ways, e.g., via a lever arrangement, via wire, or by some other form of mechanical linkage. An electric or electromechanical control actuator can also be used to control the position of the control body 2060, such as a solenoid or electromagnet. A resilient member, such as a spring 2090, can be arranged to bias the main valve closure body 2010 into the first position 2020.

The mechanism in FIG. 20 uses differential air pressure to actuate the valve mechanism. In the example of FIG. 20, a control chamber 2061 is partially defined by the control body 2060, and a volume of the control chamber 2061 is variable in relation to the position of the control body 2060. There is also a control chamber valve 2062 having an open state and a closed state for regulating a pressure P1 in the control chamber. Thus, by a change of pressure in the control chamber, the control body can be made to move, which will cause a corresponding motion of the main valve closure body 2010. The state of the control chamber valve 2062 is determined by a trigger device 2070, 2080, which will be discussed in more detail below.

In the example of FIG. 20 and FIGS. 21A-B, the control chamber 2061 is a space which is sealed by a resilient membrane which is able to move up and down to restrict or expand the volume of the control chamber (although this is not accurately represented in the drawings). The volume of the control chamber 2061 is therefore variable in relation to the position of the control body 2060. Other ways to implement this type of control chamber would, e.g., comprise a cylinder and piston arrangement, or a balloon arrangement.

With reference to FIG. 20, if the pressure P1 inside the control chamber 2061 is smaller than pressure P2 outside the control chamber 2061, the control body 2060 will move to restrict the volume in the control chamber 2061. This motion also pulls the main valve control body 2010 into the sealing position 2020, since a smaller counter-force acts on the main valve control body 2010 due to the pressure difference between the low pressure P3 side and the high pressure P2 side.

When the control chamber valve 2062 is opened to increase pressure in the control chamber 2061, e.g., from a machine operating pressure to atmospheric pressure, the main valve control body is shifted into the non-sealing position 2030, and now instead seals the suction conduit, at least in part due to being sucked against the aperture of the suction conduit (since the pressure P4 is smaller than the pressure P3). The effective area of the control body 2060 may be arranged larger than an effective area of the main valve control body 2010.

According to some aspects, the control chamber 2061 is fluidly connected to the low pressure P3 side via a connecting channel 2063 configured with a connecting channel aperture 2064, and the control chamber valve 2062 is configured with an aperture larger than the connecting channel aperture 2064 such that the control chamber valve 2062 is arranged to overcome the connecting channel 2063 when in the open state.

The valve arrangement 1250 illustrated in FIGS. 21A-B also differs from known valve arrangements in how the pressure P1 in the control chamber 2061 is regulated to trigger the air pulse for cleaning the air filter. The valve arrangement 1250 comprises a connecting channel 2063 which fluidly connects the control chamber 2061 to the low pressure P3 side. The connecting channel 2063 is a relatively narrow conduit which extends from the low pressure P3 side into the control chamber 2061 (the connecting channel aperture 2064 opens up into the control chamber 2061).

Thus, air is constantly drawn out from the control chamber 2061 towards the low pressure P3 side via the connecting channel 2063 when the dust extractor is in use. A low pressure is thereby generated in the control chamber 2061 as long as the control chamber valve 2062 is in the closed state. The control chamber valve 2062 is configured with an aperture that is larger than the aperture 2064 of the connecting channel 2063, which means that the control chamber valve is arranged to overcome the connecting channel aperture 2064 when in the open state. In this context, “to overcome” means that the pressure inside the control chamber increases if the control chamber valve 2062 is open despite the fact that the connecting channel 2063 constantly connects the control chamber to the low pressure P3 side. It is noted that the connecting channel 2063 is not closed when the air pulse is triggered, which means that no complex three-way valve or the like is required as in WO 2017/025305.

For example, the diameter of the aperture of the control chamber valve 2062 may be on the order of 15 mm for a circular aperture, which means that the area is about 175 mm2. This large aperture easily overcomes an aperture of the connecting channel 2064 which may be on the order of 3-4 mm in diameter for a circular aperture corresponding to an area of 7-13 mm2.

It is appreciated that the apertures of the control chamber valve 2062 and the connecting channel 2064 need not be circular, or even regular in shape. It is the aperture area which is important in order for the control chamber valve 2062 to be able to overcome the connecting channel 2064. An aperture of the control chamber valve 2062 which is about two times larger in area may be sufficient, although a larger difference may be preferred, such as ten times larger or more. The larger the difference in aperture is, the faster the response is to the trigger. However, a too large control chamber valve aperture may result in structural difficulties.

When the control chamber valve 2062 enters the open state the pressure in the control chamber rapidly increases due to the open connection to atmospheric pressure, i.e., the pressure inside the control chamber quickly goes from a machine operating pressure to atmospheric pressure. The effect of the connecting channel in reducing pressure is overcome, and the main valve control body is therefore shifted into the non-sealing position 2030 whereby the reverse flow of air, preferably the pulse of air, is generated to clean the filter.

The trigger device may comprise a manual control device 2070 arranged to force the control chamber valve 2062 into the open state, such as a button or other manual control input device. This button can be used to trigger filter cleaning on-demand in a convenient manner.

According to some aspects, the trigger device comprises an electrically actuated control device 2080 arranged to force the control chamber valve 2062 into the open state in response to a wired or wireless control signal. In the example of FIG. 21A-B, this electrically actuated control device 2080 is an electromagnet arranged to engage a magnetic material member 2085 (such as iron, steel, or a permanent magnet) on a control lever attached to the control chamber valve 2062, i.e., a solenoid arrangement. In this manner a control current can be made to flow in the electromagnet, whereby the magnetic material member 2085 is pulled towards the electrically actuated control device 2080 to operate the lever which in turn opens up the control chamber valve 2062.

According to some aspects, the electrically actuated control device 2080 (and the magnetic material member 2085 if it exists) are sealed from the rest of the dust extractor and in particular from the ambient environment by a seal. Thus, optionally, the electrically actuated control device 2080 is enclosed by a seal arranged to prevent foreign particles from the ambient environment and from the pre-separator tank from reducing performance of the control device or even causing malfunction. This seal, e.g., prevents foreign particles such as iron dust from entering in between the electrically actuated control device 2080 and the magnetic material member 2085, which reduces the performance of the control device 2080. The seal may comprise bellows or the like that encloses the electrically actuated control device 2080 and the magnetic material member 2085, or a cylinder defining an interior sealed volume in which the control device 2080 operates. A hermetically sealed solenoid can of course also be used as the electrically actuated control device 2080, where the seal is integrated in the control device.

The magnetic material member 2085 may as noted above be made of iron or steel. However, further advantages can be obtained if a permanent magnet having a polarity is used. In this case the electromagnet may be configurable to reverse polarity to attract and repel the magnetic material member 2085. This causes the opening and closing of the control chamber valve 2062 to be more snappy, since its opening will be rather fast due to the attraction force between electromagnet and permanent magnet. The closing of the control chamber valve 2062 will also be rapid, due to the repulsive force between electromagnet and permanent magnet as the current in the electromagnet is reversed. A two-way solenoid can of course also be used with the same technical effect.

1. A control unit for a heavy duty dust extractor,
wherein the control unit is arranged to control a valve arrangement which opens and closes a passage between a clean side of a filter of the dust extractor and atmospheric pressure,
wherein the control unit is arranged to trigger generation of reverse pulses of air for cleaning the filter by opening and closing the valve arrangement according to a pulse repetition frequency,
wherein the control unit is arranged to determine a particle load level associated with the filter, and
wherein the control unit is arranged to configure the pulse repetition frequency as an increasing function of the particle load level.

2. The control unit according to claim 1, arranged to obtain a differential pressure measurement over the filter, and to determine the particle load level based on the differential pressure measurement.

3. The control unit according to claim 1, wherein the control unit is arranged to obtain a downstream pressure measurement associated with an air pressure downstream from the filter, and to determine the particle load level based on the downstream pressure measurement.

4. The control unit according to claim 2, wherein the control unit is arranged to determine the particle load level based on an average pressure measurement associated with the filter over an averaging time period.

5. The control unit according to claim 1, wherein the control unit is arranged to configure a zero pulse repetition frequency in case the particle load level is below a pre-determined filter cleaning activation threshold.

6. The control unit according to claim 1, wherein the control unit is arranged to limit the pulse repetition frequency to be below a pre-determined maximum pulse repetition frequency.

7. The control unit according to claim 1, wherein the control unit is arranged to configure the pulse repetition frequency as an increasing polynomial function over a pre-determined range of particle load levels.

8. The control unit according to claim 1, wherein the control unit is arranged to control a time duration of each reverse pulse of air as a pre-determined function of the particle load level.

9. The control unit according to claim 1, wherein the control unit is arranged to determine a first particle load level within a pre-determined time period before a generated reverse pulse of air and a second particle load level within a pre-determined time period after a generated reverse pulse of air, wherein the control unit is arranged to determine a cleaning efficiency metric based on the difference between the first particle load level and the second particle load level.

10. The control unit according to claim 9, wherein the control unit is arranged to display the cleaning efficiency metric on a display device.

11. The control unit according to claim 9, wherein the control unit is arranged to configure the pulse repetition frequency and/or the pulse time duration as an increasing function of the cleaning efficiency metric.

12. The control unit according to claim 9, wherein the control unit is arranged to trigger a super-clean procedure in response to the particle load level and/or cleaning efficiency metric breaching a super-clean trigger threshold, wherein the super-clean procedure comprises blocking an inlet of the dust extractor and triggering generation of a series of reverse pulses of air for cleaning the filter.

13. The control unit according to claim 12, wherein blocking the inlet of the dust extractor comprises issuing an instruction to a user to manually block the inlet or controlling an automatic inlet blocking device of the dust extractor to block the inlet.

14. The control unit according to claim 1, wherein the control unit is arranged to update a filter cleaning counter each time a reverse pulse of air for cleaning the filter is triggered, and to determine a filter state based on the value of the filter cleaning counter, and the control unit is arranged to display the filter state on a display device.

15. (canceled)

16. The control unit according to claim 14, wherein the control unit is arranged to trigger generation of a notification message in case the value of the filter cleaning counter exceeds a pulse counter threshold.

17. (canceled)

18. The control unit according to claim 1, wherein the control unit is arranged to configure the pulse repetition frequency as a function of an air flow through the filter.

19. The control unit according to claim 1, wherein the control unit is arranged to configure a pulse time duration of the reverse pulses of air as a function of an air flow through the filter.

20. (canceled)

21. The control unit according to claim 1, wherein the control unit is arranged to control a first valve arrangement and a second valve arrangement, wherein each valve arrangement opens and closes a passage between a clean side of a respective filter of the dust extractor and atmospheric pressure,
wherein the dumping operation comprises generation of compact sequences of short reverse pulses of air by the first valve arrangement and by the second valve arrangement, followed by a longer synchronized reverse pulse of air by the first valve arrangement and by the second valve arrangement.

22-28. (canceled)

29. A control unit for a heavy duty dust extractor,
wherein the control unit is arranged to trigger generation of reverse pulses of air for cleaning a filter of the dust extractor by opening and closing a valve arrangement,
wherein the control unit is arranged to execute a dumping operation, the dumping operation comprising generation of a compact sequence of short reverse pulses of air followed by a longer reverse pulse of air.

30-51. (canceled)

52. A dust extractor comprising a cyclone, a filter, a valve arrangement, and a control unit,
wherein the valve arrangement is arranged to open and close a passage between a clean side of the filter of the dust extractor and atmospheric pressure,
wherein the control unit is arranged to control the valve arrangement to generate a vibration of the cyclone, by repeatedly opening and closing the valve arrangement according to a compact sequence of short reverse pulses of air,
wherein the compact sequence of short reverse pulses of air comprises at least two short pulses in a time period of 150-250 ms.

53. (canceled)
